(19) United States
(12) Patent Application Publication
(10) Pub. No.: US 2020/0276964 A1
(43) Pub. Date: Sep. 3, 2020

(54) ELECTRIC BOOSTER

(71) Applicant: HITACHI AUTOMOTIVE SYSTEMS, LTD., Ibaraki (JP)

(72) Inventors: Daisuke GOTO, Atsugi-shi, Kanagawa (JP); Takuya USUI, Yokohama-shi, Kanagawa (JP)

(21) Appl. No.: 16/647,651

(22) PCT Filed: Sep. 18, 2018
(86) PCT No.: PCT/JP2018/034541

§ 371 Date: Mar. 16, 2020

(30) Foreign Application Priority Data
Sep. 25, 2017 (JP) 183535/2017

(51) Int. Cl. B60T 13/74; B60T 13/04; B60T 7/12; B60T 7/04; B60T 13/10

(52) U.S. Cl. CPC B60T 13/745; B60T 13/04; B60T 13/10; B60T 7/042; B60T 7/12

(57) ABSTRACT

A brake operation sensor detects a position of an input member. An angle sensor detects a position of a power piston. An ECU drives and controls an electric motor based on a relative position between the input member and the power piston. Then, the input member and the power piston are subjected to a mechanical limitation on a relative displacement therebetween due to abutment with each other at a step. The ECU advances/retracts the power piston independently of the movement of the input member, and determines the abutment state between the input member and the power piston under the mechanical limitation based on the detected relative position. Then, the ECU corrects the relative position between the input member and the power piston based on this determination to control the electric motor.

### TECHNICAL FIELD

The present invention relates to an electric booster that applies a braking force to a vehicle such as an automobile.

### BACKGROUND ART

An electric booster configured to use an electric actuator is known as a booster (a brake booster) mounted on a vehicle such as an automobile. The electric booster can supply a brake hydraulic pressure to a wheel brake mechanism of the vehicle with use of the electric actuator. Now, PTL 1 discusses an electric booster configured to be able to acquire various brake characteristics by variably controlling a relative position between an input member displaceable according to an operation on a brake pedal and an assist member advanceable and retractable by the electric actuator.

### CITATION LIST

### Patent Literature

[PTL 1] Japanese Patent Application Public Disclosure No. 2011-235894

### SUMMARY OF INVENTION

### Technical Problem

Then, the electric booster like the example discussed in PTL 1 can acquire the various brake characteristics by changing the relative position between the assist member and the input member according to an amount of the operation on the brake pedal. However, an error may be generated between a relative position recognized by a control apparatus and an actual relative position due to an error of a sensor for detecting the relative position, a variation in a mechanical tolerance, and the like. Then, the brake characteristic may be changed according to this error (i.e., the brake characteristic may deviate from a desired brake characteristic).

### Solution to Problem

An object of the present invention is to provide an electric booster capable of preventing the change in the brake characteristic.

According to one aspect of the present invention, an electric booster includes an input member configured to receive transmission of a part of a reaction force from a piston of a master cylinder coupled with a brake pedal, an assist member advanceable and retractable relative to this input member, an electric actuator configured to thrust the assist member forward by the movement of the input member, a reaction force distribution member configured to combine thrust forces of the input member and the assist member to transmit them to the piston of the master cylinder, and distribute the reaction force from the piston to the input member and the assist member, and a control device configured to detect a relative position between the input member and the assist member, and drive and control the electric actuator. The input member is subjected to a mechanical limitation on a displacement thereof relative to the assist member. The control device moves forward/backward the assist member independently of the movement of the input member and determines an abutment state between the input member and the assist member under the mechanical limitation based on the detected relative position, and corrects the relative position between the input member and the assist member to control the electric actuator.

The electric booster according to the one aspect of the present can prevent the change in the brake characteristic.

### BRIEF DESCRIPTION OF DRAWINGS

FIG. 1 schematically illustrates a vehicle on which an electric booster according to a first embodiment is mounted.

FIG. 2 is a vertical cross-sectional view illustrating the electric booster illustrated in FIG. 1 in an enlarged manner.

FIG. 3 is a control block diagram illustrating the electric booster, a master cylinder, a wheel brake mechanism, and the like.

FIG. 4 are enlarged cross-sectional views each illustrating a reaction disk in a state elastically deformed between an input piston and a power piston, and an output rod.

FIG. 5 illustrates a characteristic line representing a relationship between an input rod load and a hydraulic reaction force.

FIG. 6 illustrates a characteristic line representing a change in the relationship between the input rod load and the hydraulic reaction force due to an error in a relative displacement amount.

FIG. 7 is a control block diagram specifically illustrating a relative displacement amount calculation processing portion illustrated in FIG. 3.

FIG. 8 are schematic half cross-sectional views illustrating motions of the power piston, the input member, the output rod, and the like.

FIG. 9 illustrates characteristic lines representing one example of changes in a position of the power piston and a position of the input member over time.

FIG. 10 illustrates a characteristic line representing one example of a relationship between the position of the input member and a detection error.

FIG. 11 are schematic half cross-sectional views illustrating motions of the power piston, the input member, the output rod, and the like according to a second embodiment.

FIG. 12 illustrate characteristic lines representing one example of changes in the position of the power piston and a motor electric current over time.

### DESCRIPTION OF EMBODIMENTS

In the following description, an electronic booster according to embodiments will be described in detail with reference to the accompanying drawings based on an example in which this electric booster is mounted on a four-wheeled automobile.

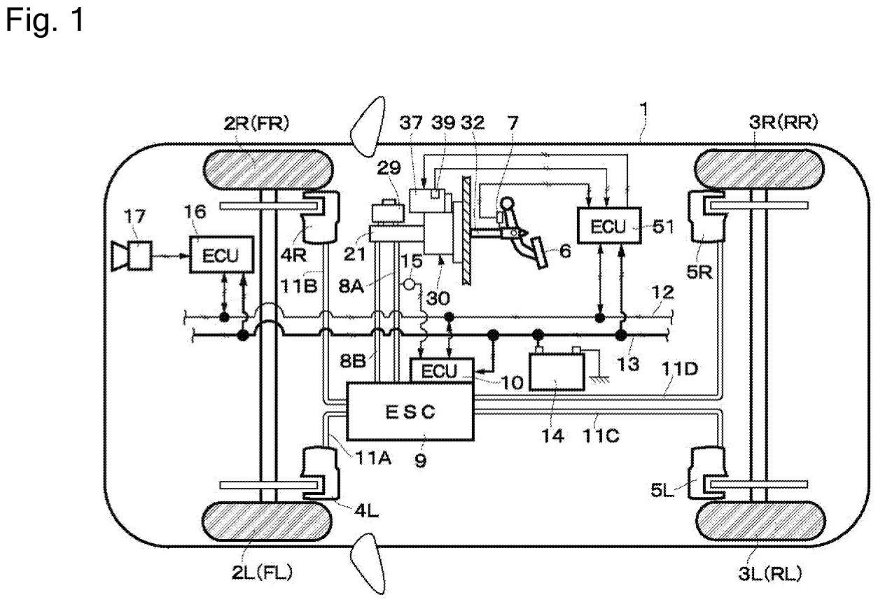

FIGS. 1 to 10 illustrate a first embodiment. In FIG. 1, four wheels in total that include front left and right wheels 2L and 2R and rear left and right wheels 3L and 3R are mounted on a vehicle body 1 forming a main structure of a vehicle under (on a road surface side of) it. These wheels (i.e., the front wheels 2L and 2R and the rear wheels 3L and 3R) form the vehicle together with the vehicle body 1. Front wheel-side wheel cylinders 4L and 4R are mounted on the front left and right wheels 2L and 2R, respectively. Rear wheel-side wheel cylinders 5L and 5R are mounted on the rear left and right wheels 3L and 3R, respectively. These individual wheel cylinders 4L, 4R, 5L, and 5R serve as a wheel brake mechanism (a frictional brake mechanism) that applies braking forces (frictional braking forces) to the respective wheels 2L, 2R, 3L, and 3R, and is, for example, constructed with use of, for example, a hydraulic disk brake or a drum brake.

A brake pedal 6 is provided on a dashboard side of the vehicle body 1. The brake pedal 6 is operated by being pressed by a driver when a braking force is provided to the vehicle. At this time, each of the wheel cylinders 4L, 4R, 5L and 5R applies the braking force based on a brake hydraulic pressure to the wheel 2L, 2R, 3L, or 3R. A brake operation sensor 7 is provided on the brake pedal 6 (more specifically, an input member 32 of an electric booster 30, which will be described below). The brake operation sensor 7 functions as an operation amount detector that detects an operation amount of the brake pedal 6 (a brake pedal operation amount) that is input by the driver.

The brake operation sensor 7 can be embodied by, for example, a stroke sensor (a displacement sensor) that detects a stroke amount (a pedal stroke) corresponding to a displacement amount of the brake pedal 6 (the input member 32). The brake operation sensor 7 is not limited to the stroke sensor, and can be embodied by various kinds of sensors capable of detecting the operation amount (a pressing amount) of the brake pedal 6 (the input member 32), such as a force sensor that detects a pedal pressing force (a load sensor), and an angle sensor that detects a rotational angle (a tilt) of the brake pedal 6. In this case, the brake operation sensor 7 may be constructed with use of one (one kind of) sensor or may be constructed with use of a plurality of (a plurality of kinds of) sensors.

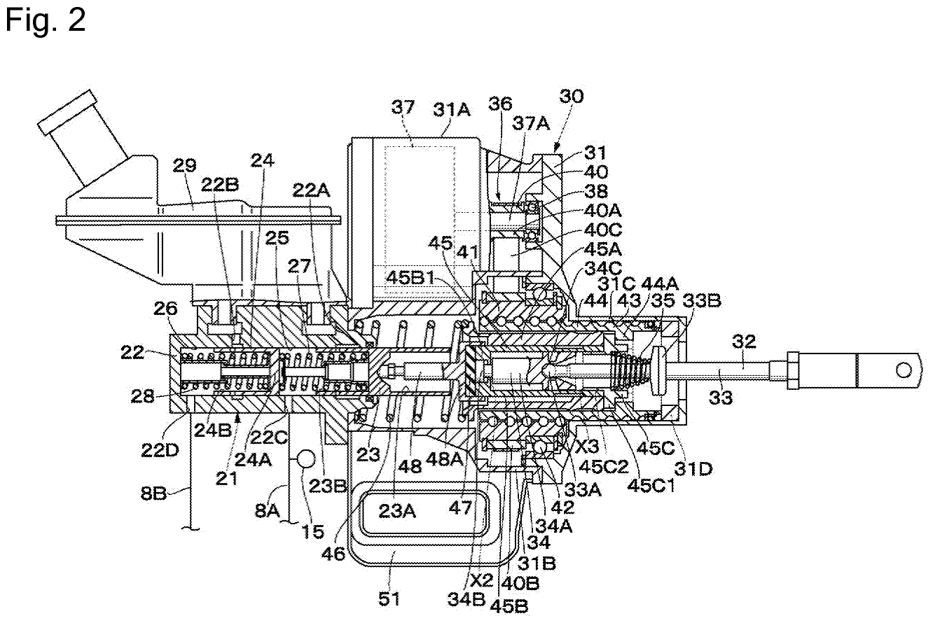

A detection signal of the brake operation sensor 7 (a brake operation amount) is output to an electric booster ECU 51 (hereinafter referred to as an ECU 51), which will be described below. The ECU 51 forms the electric booster 30, which will be described below, together with the brake operation sensor 7 and the like. As will be described below, the ECU 51 outputs a driving signal to an electric motor 37 of the electric booster 30 based on the brake pedal operation amount of the brake operation sensor 7 (a first braking instruction value), thereby causing a hydraulic pressure (the brake hydraulic pressure) to be generated in hydraulic chambers 25 and 26 (refer to FIG. 2) in a master cylinder 21 attached to the electric booster 30.

Further, the ECU 51, for example, also causes the hydraulic pressure to be generated in the master cylinder 21 when receiving an autonomous brake instruction (a second braking instruction value) via a vehicle data bus 12, which will be described below. At this time, the ECU 51 can output the driving signal to the electric motor 37 of the electric booster 30 based on the autonomous brake instruction to cause the hydraulic pressure to be generated in the hydraulic chambers 25 and 26 in the master cylinder 21 independently of the operation performed on the brake pedal 6 by the driver.

The hydraulic pressure generated in the master cylinder 21 is supplied to each of the wheel cylinders 4L, 4R, 5L, and 5R via a hydraulic pressure supply apparatus 9, and the braking force is applied to each of the wheels 2L, 2R, 3L, and 3R. Configurations of the master cylinder 21, a reservoir 29, the electric booster 30, and the like illustrated in FIGS. 2 to 4 will be described in detail below.

As illustrated in FIG. 1, the hydraulic pressure generated in the master cylinder 21 is supplied to the hydraulic pressure supply apparatus 9 (hereinafter referred to as an ESC 9) via, for example, a pair of cylinder-side hydraulic pipes 8A and 8B. The ESC 9 is provided between the master cylinder 21 and the wheel cylinders 4L, 4R, 5L, and 5R. The ESC 9 distributes and supplies the hydraulic pressure output from the master cylinder 21 via the cylinder-side hydraulic pipes 8A and 8B to the wheel cylinders 4L, 4R, 5L, and 5R via brake-side pipe portions 11A, 11B, 11C, and 11D, respectively.

The ESC 9 includes, for example, a plurality of control valves, a hydraulic pump, an electric motor, and a hydraulic control reservoir (none of them illustrated). The hydraulic pump increases a pressure of the brake fluid. The electric motor drives this hydraulic pump. The hydraulic control reservoir temporarily stores extra brake fluid therein. Opening/closing of each of the control valves and driving of the electric motor of the ESC 9 are controlled by a hydraulic pressure supply apparatus ECU 10 (hereinafter referred to as an ECU 10).

The ECU 10, which corresponds to a first ECU, includes, for example, a microcomputer, a driving circuit, and an electric power source circuit. The microcomputer includes, for example, a memory including a flash memory, a ROM, a RAM, an EEPROM, and/or the like (none of them illustrated), in addition to an arithmetic device (a CPU). The ECU 10 is a hydraulic pressure supply apparatus control unit that electrically controls driving of the ESC 9 (each of the control valves and the electric motor thereof). An input side of the ECU 10 is connected to the vehicle data bus 12 and a hydraulic sensor 15. An output side of the ECU 10 is connected to each of the control valves of the ESC 9, the electric motor, and the vehicle data bus 12. The ECU 10 controls the driving of each of the control valves, the electric motor, and the like of the ESC 9 individually. By this control, the ECU 10 performs control of reducing, maintaining, increasing, or pressurizing the brake hydraulic pressures to be supplied from the brake-side pipe portions 11A, 11B, 11C, and 11D to the wheel cylinders 4L, 4R, 5L, and 5R, respectively, for each of the wheel cylinders 4L, 4R, 5L, and 5R individually.

In this case, the ECU 10 can perform, for example, the following kinds of control (1) to (8) by controlling the actuation of the ESC 9.

(1) braking force distribution control of appropriately distributing the braking force to each of the wheels 2L, 2R, 3L, and 3R according to a vertical load and the like when the vehicle is braked
(2) anti-lock brake control of preventing each of the wheels 2L, 2R, 3L, and 3R from being locked (slipped) by automatically adjusting the braking force provided to each of the wheels 2L, 2R, 3L, and 3R when the vehicle is braked
(3) vehicle stabilization control of stabilizing a behavior of the vehicle, by preventing or reducing understeer and oversteer while detecting a sideslip of each of the wheels 2L, 2R, 3L, and 3R when the vehicle is running to thus appropriately automatically control the braking force to be applied to each of the wheels 2L, 2R, 3L, and 3R regardless of the operation amount of the brake pedal 6
(4) hill start aid control of aiding a start by maintaining a braked state on a slope
(5) traction control of preventing each of the wheels 2L, 2R, 3L, and 3R from idly spinning, for example, when the vehicle starts running
(6) adaptive cruise control of maintaining a predetermined distance to a vehicle running ahead
(7) traffic lane departure avoidance control of maintaining the vehicle within a traffic lane
(8) obstacle avoidance control of avoiding a collision with an obstacle located in a direction in which the vehicle is traveling (a collision avoidance system)

The ESC 9 directly supplies the hydraulic pressure generated in the master cylinder 21 to the wheel cylinders 4L, 4R, 5L, and 5R at the time of, for example, a normal operation in response to the brake operation performed by the driver. On the other hand, for example, the ESC 9 maintains the hydraulic pressures in the wheel cylinders 4L, 4R, 5L and 5R by closing a control valve for the pressure increase when performing the anti-lock brake control or the like, and discharges the hydraulic pressures in the wheel cylinders 4L, 4R, 5L, and 5R as if releasing them to the hydraulic control reservoir by opening a control valve for the pressure reduction when reducing the hydraulic pressures in the wheel cylinders 4L, 4R, 5L, and 5R.

Further, the ESC 9 actuates the hydraulic pump by the electric motor with a control valve for the supply closed, thereby supplying the brake fluid discharged from this hydraulic pump to the wheel cylinders 4L, 4R, 5L, and 5R when increasing or pressurizing the hydraulic pressures to be supplied to the wheel cylinders 4L, 4R, 5L, and 5R to perform, for example, the stabilization control (electronic stability control) when the vehicle is running. At this time, for example, the brake fluid in the reservoir 29 is supplied from the master, cylinder 21 side toward an intake side of the hydraulic pump.

The vehicle data bus 12 is a communication network between vehicle ECUs called a V-CAN that is mounted on the vehicle. More specifically, the vehicle data bus 12 is a serial communication portion that establishes multiplex communication among a large number of electric apparatuses (for example, among the ECU 10, an ECU 16, and the ECU 51) mounted on the vehicle. Electric power is supplied from an in-vehicle battery 14 to the ECU 10 via an electric power line 13. Electric power is also supplied from the in-vehicle battery 14 to the ECU 16 and the ECU 51, which will be described below, via the electric power line 13. In FIG. 1, a line with two slash marks added thereto indicates an electricity-related line such as a signal line and an electric power source line.

A hydraulic sensor 15 is provided in, for example, the cylinder-side hydraulic pipe 8A between the master cylinder 21 (the first hydraulic chamber 25 thereof) and the ECU 9. The hydraulic sensor 15 is a hydraulic pressure detection portion that detects the pressure (the brake hydraulic pressure) generated in the master cylinder 21, i.e., a hydraulic pressure in the cylinder-side hydraulic pipe 8A. The hydraulic sensor 15 is electrically connected to the ECU 10 of the ESC 9. A detection signal of the hydraulic sensor 15 (a hydraulic value) is output to the ECU 10. The ECU 10 outputs the hydraulic value detected by the hydraulic sensor 15 to the vehicle data bus 12. The electric booster ECU 51, which will be described below, can monitor (acquire) the hydraulic value generated in the master cylinder 21 by receiving the hydraulic value from the ECU 10.

The ECU 10 and the ECU 51 may be connected to each other via a communication line (a signal line) provided separately from the vehicle data bus 12, such as a communication line called an L-CAN capable of establishing communication between in-vehicle ECUs (i.e., the communication network between vehicle ECUs), and be configured to transmit and receive the hydraulic value of the hydraulic sensor 15 via this communication line, although this configuration is not illustrated in FIG. 1. In other words, the electric booster ECU 51 can acquire the hydraulic value detected by the hydraulic sensor 15 from the ECU 10 via the communication network between vehicle ECUs (the vehicle data bus 12 or the communication line).

The autonomous brake ECU 16 (hereinafter referred to as the ECU 16) is connected to the vehicle data bus 12. The ECU 16, which corresponds to a second ECU, is an autonomous brake control unit that outputs an autonomous brake instruction (an autonomous brake braking instruction value). The ECU 16 also includes a microcomputer similarly to the ECU 10 and the ECU 51, which will be described below, and is connected to the ECUs 10 and 51 and the like via the vehicle data bus 12.

Now, the ECU 16 is connected to, for example, an eternal world recognition sensor 17. The external world recognition sensor 17 forms an object position measurement device that measures a position of an object located around the vehicle, and can be embodied by a camera such as a stereo camera and a single camera (for example, a digital camera), and/or a radar such as a laser radar, an infrared radar, and a millimeter-wave radar (for example, a light emitting element such as a semiconductor radar and a light receiving element that receives it). The external world recognition sensor 17 is not limited to the camera and the radar, and may be embodied by various kinds of sensors (a detection device, a measurement device, and a radiodetector) capable of recognizing (detecting) a state of the external world, which is a neighborhood around the vehicle.

The ECU 16 calculates, for example, a distance to an object located in front of the vehicle based on a result (information) of the detection by the external world recognition sensor 17, and also calculates the autonomous brake braking instruction value corresponding to the braking force (the braking hydraulic pressure) to apply based on this distance, the present running speed of the vehicle, and the like. The calculated autonomous brake braking instruction value is output from the ECU 16 to the vehicle data bus 12 as the autonomous brake instruction.

In this case, for example, upon acquiring the autonomous brake braking instruction value (a second braking instruction value) via the vehicle data bus 12, the electric booster ECU 51, which corresponds to a third ECU, drives the electric motor 37 of the electric booster 30 based on this acquired autonomous brake braking instruction value. In other words, the electric booster 30 can apply the braking force to each of the wheels 2L, 2R, 3L, and 3R by causing the hydraulic pressure to be generated in the master cylinder 21 to increase the pressure in each of the wheel cylinders 4L, 4R, 5L, and 5R based on the autonomous brake braking instruction value (the autonomous brake).

Next, the master cylinder 21, the reservoir 29, and the electric booster 30 will be described with additional reference to FIG. 2, along with FIG. 1.

The master cylinder 21 is actuated by the brake operation performed by the driver. The master cylinder 21 is a cylinder device that supplies the brake hydraulic pressure to the wheel cylinders 4L, 4R, 5L, and 5R, which apply the braking force to the vehicle. As illustrated in FIG. 2, the master cylinder 21 includes a tandem-type master cylinder. More specifically, the master cylinder 21 includes a cylinder main body 22, a primary piston 23, a secondary piston 24, the first hydraulic chamber 25, the second hydraulic chamber 26, a first return spring 27, and a second return spring 28.

The cylinder main body 22 is formed into a closed bottomed cylindrical shape having an opened end on one side thereof (for example, a right side in a horizontal direction in FIG. 2 and a rear side in a longitudinal direction of the vehicle) and a bottom portion on the other side thereof (for example, a left side in the horizontal direction in FIG. 2 and a front side in the longitudinal direction of the vehicle) in an axial direction (the horizontal direction in FIG. 2). The cylinder main body 22 is attached at the opening end side thereof to a booster housing 31 of the electric booster 30, which will be described below. First and second reservoir ports 22A and 22B connected to the reservoir 29 are provided on the cylinder main body 22. Further, first and second supply ports 22C and 22D, to which the cylinder-side hydraulic pipes 8A and 8B are connected, are provided on the cylinder main body 22. The first and second supply ports 22C and 22D are connected to the wheel cylinders 4L, 4R, 5L, and 5R via the cylinder-side hydraulic pipes 8A and 8B, and the like.

The primary piston 23 includes a bottomed rod insertion hole 23A on one axial side thereof and a bottomed spring containing hole 23B on the other axial side thereof. The spring containing hole 23B is opened to an opposite side from the rod insertion hole 23A (opened to the other side), and one side of the first return spring 27 is disposed in the spring containing hole 23B. The rod insertion hole 23A side of the primary piston 23 protrudes outward from the opening end side of the cylinder main body 22, and an output rod 48, which will be described below, is inserted in the rod insertion hole 23A in an abutment state.

The secondary piston 24 is formed into a bottomed cylindrical shape, and is closed at a bottom portion 24A formed on one axial side thereof that faces the primary piston 23. A spring containing hole 24B, which is opened to the other axial side, is formed at the secondary piston 24, and one side of the second return spring 28 is disposed in the spring containing hole 24B.

The first hydraulic chamber 25 is defined between the primary piston 23 and the secondary piston 24. The second hydraulic chamber 26 is defined between the secondary piston 24 and a bottom portion of the cylinder main body 22. The first and second hydraulic chambers 25 and 26 are formed so as to be axially spaced apart from each other in the cylinder main body 22.

The first return spring 27 is positioned in the first hydraulic chamber 25, and is arranged between the primary piston 23 and the secondary piston 24. The first return spring 27 biases the primary piston 23 toward the opening end side of the cylinder main body 22. The second return spring 28 is positioned in the second hydraulic chamber 26, and is arranged between the bottom portion of the cylinder main body 22 and the secondary piston 24. The second return spring 28 biases the secondary piston 24 toward the first hydraulic chamber 25 side.

For example, when the brake pedal 6 is operated by being pressed, the primary piston 23 and the secondary piston 24 are displaced toward the bottom portion side of the cylinder main body 22 in the cylinder main body 22 of the master cylinder 21. At this time, when the first and second reservoir ports 22A and 22B are blocked by the primary piston 23 and the secondary piston 24, respectively, the brake hydraulic pressure (an M/C pressure) is generated from the master cylinder 21 by the brake fluid in the first and second hydraulic chambers 25 and 26. On the other hand, when the operation on the brake pedal 6 is released, the primary piston 23 and the secondary piston 24 are displaced toward the opening portion side of the cylinder main body 22 by the first and second return springs 27 and 28, respectively.

The reservoir 29 is attached to the cylinder main body 22 of the master cylinder 21. The reservoir 29 is configured as a hydraulic oil tank that stores the brake fluid therein, and replenishes (supplies and discharges) the brake fluid into each of the hydraulic chambers 25 and 26 in the cylinder main body 22. As illustrated in FIG. 2, when the first reservoir port 22A is in communication with the first hydraulic chamber 25 and the second reservoir port 22B is in communication with the second hydraulic chamber 26, the brake fluid can be supplied or discharged between the reservoir 29 and the hydraulic chambers 25 and 26.

On the other hand, when the first reservoir port 22A is disconnected from the first hydraulic chamber 25 by the primary piston 23 and the second reservoir port 22B is disconnected from the second hydraulic chamber 26 by the secondary piston 24, the supply and the discharge of the brake fluid are stopped between the reservoir 29 and the hydraulic chambers 25 and 26. In this case, the brake hydraulic pressure (the M/C pressure) is generated in the hydraulic chambers 25 and 26 of the master cylinder 21 according to the displacements of the primary piston 23 and the secondary piston 24, and this brake hydraulic pressure is supplied from the first and second supply ports 22C and 22D to the ESC 9 via the pair of cylinder-side hydraulic pipes 8A and 8B.

The electric booster 30 as an electric brake apparatus is provided between the brake pedal 6 and the master cylinder 21. The electric booster 30 serves as a boosting mechanism (a booster) that transmits the brake operation force (the pressing force) to the master cylinder 21 while powering up this force by driving the electric motor 37 according to the brake pedal operation amount (the pressing amount), which corresponds to the first braking instruction value, when the operation of pressing the brake pedal 6 is performed by the driver. In addition thereto, the electric booster 30 serves as an autonomous brake application mechanism that autonomously applies the braking force (the autonomous brake) even without the brake operation (the pedal operation) performed by the driver.

In other words, the electric booster 30 causes the brake hydraulic pressure to be generated in the master cylinder 21 by driving the electric motor 37 according to the autonomous brake instruction, which corresponds to the second braking instruction value (for example, from the ECU 16). Due to this configuration, the electric booster 30 can supply the brake hydraulic pressure into each of the wheel cylinders 4L, 4R, 5L, and 5R regardless of the brake operation by the driver (regardless of whether the operation is present or absent), thereby autonomously applying the braking force (the autonomous brake).

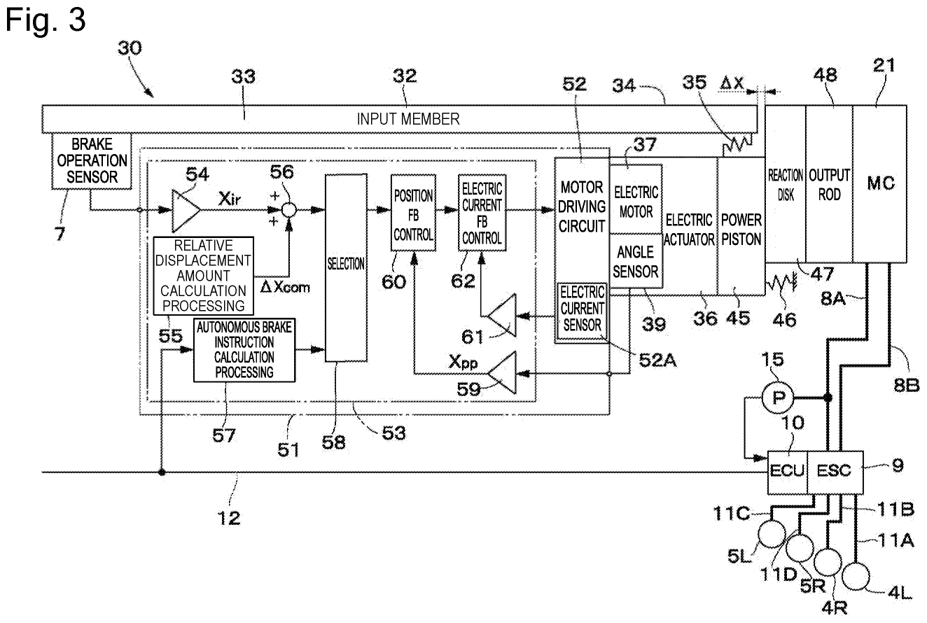

The electric booster 30 includes the brake operation sensor 7 (refer to FIGS. 1 and 3) as an operation amount detector, an input member 32, an electric actuator 36, an angle sensor 39 (refer to FIGS. 1 and 3) as a movement amount detection portion, a power piston 45 as an assist member, a reaction disk 47 as a reaction force distribution member, and the ECU 51 as a control device. More specifically, the electric booster 30 includes the brake operation sensor 7, the booster housing 31 as a housing, the input member 32, the electric actuator 36, the angle sensor 39, the power piston 45, the reaction disk 47, an output rod 48, the ECU 51, and the like.

The booster housing 31 forms an outer shell of the electric booster 30, and is fixed to, for example, a front wall of a vehicle compartment, which is the dashboard of the vehicle body 1. The booster housing 31 includes a motor case 31A, an output case 31B, and an input case 31C. The motor case 31A contains therein the electric motor 37 and a part (a driving pulley 40A side) of a speed reduction mechanism 40, which will be described below. The output case 31B contains therein the other portion (a driven pulley 40B side) of the speed reduction mechanism 40, a part (the other axial side) of a rotation-linear motion conversion mechanism 43 and the power piston 45, the second return spring 46, the output rod 48, the reaction disk 47, and the like. The input case 31C closes openings of the motor case 31A and the output case 31B on one axial sides thereof, and also contains therein the other portion (one axial side) of the rotation-linear motion conversion mechanism 43 and the power piston 45, an intermediate portion of the input member 32, and the like.

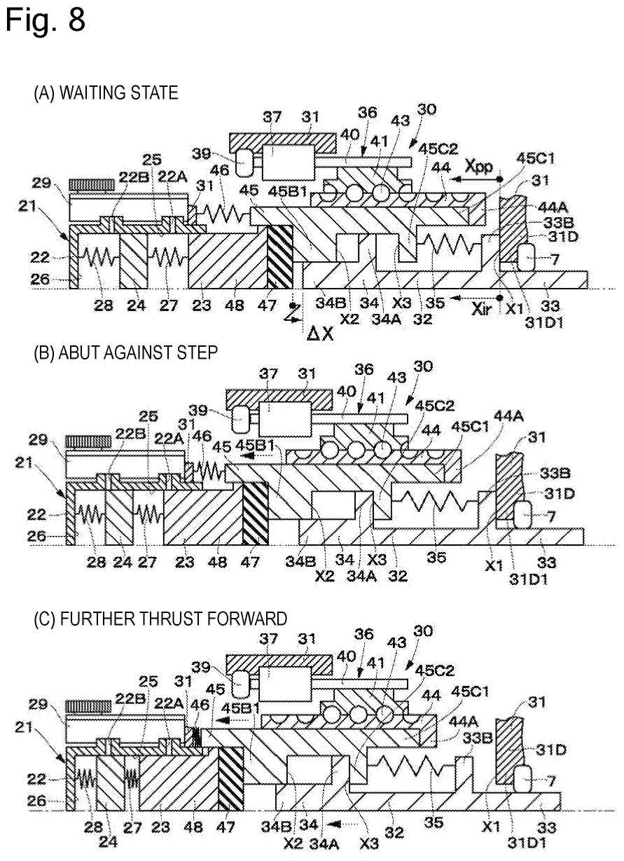

An annular stopper member 31D in abutment with a flange portion 33B of the input member 32 is provided on an opening of the input case 31C on one side thereof. Stopper pieces 31D1 (not illustrated in FIG. 2, and refer to FIG. 8) protruding radially inward are provided on the stopper member 31D at two circumferential locations (for example, two locations spaced apart from each other by 180 degrees). The flange portion 33B of the input member 32 is brought into abutment with the stopper pieces 31D1 of the stopper member 31D, by which the input member 32 is prohibited from being displaced toward the one axial side (the rear side, and the right side in FIG. 2) more than that. In other words, the stopper member 31D (the stopper pieces 31D1 thereof) serve as a step (a positioning step X1 and refer to FIG. 8) that positions the input member 32 by being brought into abutment the flange portion 33B of the input member 32 when the input member 32 is displaced toward the rear side (the right side in FIG. 2), which corresponds to the one axial side.

The input member 32 is provided axially movably relative to the booster housing 31, and is connected to the brake pedal 6. A part of a reaction force from the primary piston 23 of the master cylinder 21 coupled with the brake pedal 6 is transmitted to the input member 32. To fulfill this function, the input member 32 includes an input rod 33 and an input piston 34. The input rod 33 and the input piston 34 are inserted through inside the rotation-linear motion conversion mechanism 43 and the power piston 45 in a concentrically connected state. In this case, one axial side of the input rod 33 protrudes from the input case 31C of the booster housing 31. Then, the brake pedal 6 is coupled to the one axial side of the input rod 33 that corresponds to a protrusion end thereof.

On the other hand, the other axial side of the input rod 33 includes a spherical portion 33A formed on a distal end thereof, and this spherical portion 33A is inserted in the power piston 45. The annular flange portion 33B is provided at an axial center of the input rod 33. The flange portion 33B protrudes radially outward along an entire circumference. A first return spring 35 is provided between this flange portion 33B and the power piston 45. The first return spring 35 constantly biases the input member 32 (the input rod 33) relative to the power piston 45 toward the one axial side.

The input piston 34 is fittedly inserted in the power piston 45 axially movably (slidably) relative to the power piston 45. The input piston 34 includes a piston main body 34A and a pressure reception portion 34B. The piston main body 34A is provided so as to face the input rod 33. The pressure reception portion 34B is provided so as to protrude from this piston main body 34A toward the other axial direction. A recessed portion 34C is provided on one axial side of the piston main body 34A at a position corresponding to the spherical portion 33A of the input rod 33. The spherical portion 33A of the input rod 33 is fixed in the recessed portion 34C with use of a method such as crimping.

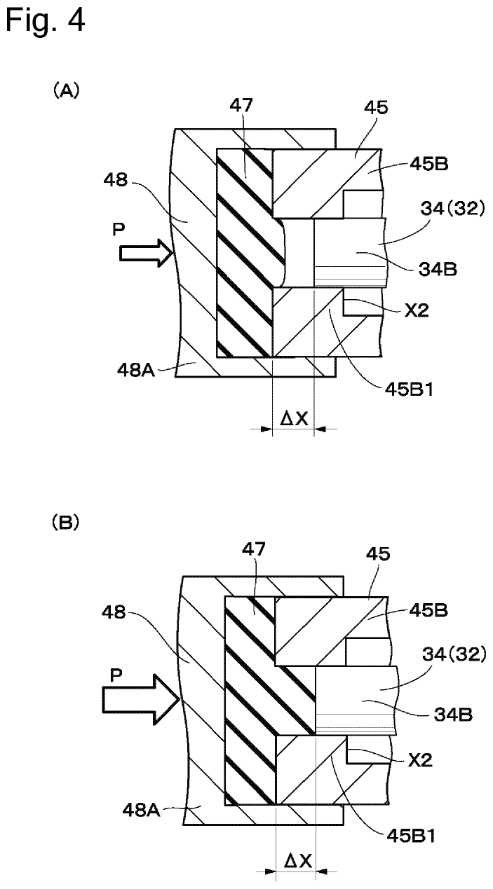

On the other hand, a distal end surface of the pressure reception portion 34B serves as an abutment surface abuttable against the reaction disk 47. For example, when the vehicle is not braked without the brake pedal 6 operated, a predetermined space is formed between the distal end surface of the pressure reception portion 34B and the reaction disk 47. When the brake pedal 6 is operated by being pressed, the distal end surface of the pressure reception portion 34B and the reaction disk 47 are brought into abutment with each other, and a thrust force of the input member 32 (the pressing force) is applied to the reaction disk 47 (refer to FIG. 4).

The electric actuator 36 is actuated when the hydraulic pressure is supposed to be generated from the master cylinder 21, and applies the braking hydraulic pressure to each of the wheel cylinders 4L, 4R, 5L, and 5R of the vehicle. In this case, the electric actuator 36 thrusts the power piston 45 as the assist member forward by the movement of the input member 32. In other words, the electric actuator 36 causes the power piston 45 to be moved in the axial direction of the master cylinder 21 and applies a thrust force to this power piston 45. As a result, the power piston 45 axially displaces the primary piston 23 (and the secondary piston 24) in the cylinder main body 22 of the master cylinder 21.

The electric actuator 36 includes the electric motor 37, the speed reduction mechanism 40, a cylindrical rotational member 41, and the rotation-linear motion conversion mechanism 43. The speed reduction mechanism 40 slows down the rotation of this electric motor 37. The rotation slowed by this speed reduction mechanism 40 is transmitted to the cylindrical rotational member 41. The rotation-linear motion conversion mechanism 43 converts the rotation of this cylindrical rotational member 41 into the axial displacement of the power piston 45. The electric motor 37 is constructed with use of, for example, a DC brushless motor, and includes a rotational shaft 37A, a rotor (not illustrated), and a stator (not illustrated). The rotational shaft 37A functions as a motor shaft (an output shaft). The rotor is, for example, a permanent magnet attached to this rotational shaft 37A. The stator is, for example, a coil (an armature) attached to the motor case 31A. An end portion of the rotational shaft 37A on one axial side thereof is rotatably supported by the input case 31C of the booster housing 31 via a roller bearing 38.

The electric motor 37 is provided with the angle sensor 39 (refer to FIGS. 1 and 3) called a resolver or a rotational angle sensor. Then angle sensor 39 detects a rotational angle (a rotational position) of the electric motor 37 (the rotational shaft 37A thereof), and outputs a detection signal thereof to the ECU 51. The ECU 51 performs feedback control on the rotational position of the electric motor 37 (i.e., the displacement of the power piston 45) according to this rotational angle signal. Then, based on the rotational angle of the electric motor 37 that is detected by the angle sensor 39, a movement amount (a displacement amount or a position) of the power piston 45 can be calculated by using a speed reduction ratio of the speed reduction mechanism 40, which will be described below, and a linear displacement amount per unit rotational angle of the rotation-linear motion conversion mechanism 43.

Therefore, the angle sensor 39 forms the movement amount detection portion that detects the movement amount of the power piston 45 (a power piston position). The movement amount detection portion is not limited to the angle sensor 39 including the resolver, and may be embodied by, for example, a rotary potentiometer. Further, the angle sensor 39 may detect the rotational angle after the speed is slowed down by the speed reduction mechanism 40 (for example, a rotational angle of the cylindrical rotational member 41) instead of the rotational angle (the rotational position) of the electric motor 37. Alternatively, for example, a displacement sensor (a position sensor) that directly detects the linear displacement (the axial displacement) of the power piston 45 may be used instead of the angle sensor 39 that indirectly detects the movement amount of the power piston 45. Alternatively, the linear displacement of a linear motion member 44 of the rotation-linear motion conversion mechanism 43 may be detected with use of a displacement sensor.

The speed reduction mechanism 40 is configured as, for example, a belt speed reduction mechanism. The speed reduction mechanism 40 includes the driving pulley 40A, the driven pulley 40B, and a belt 40C. The driving pulley 40A is attached to the rotational shaft 37A of the electric motor 37. The driven pulley 40B is attached to the cylindrical rotational member 41. The belt 40C is wound around between them. The speed reduction mechanism 40 transmits the rotation of the rotational shaft 37A of the electric motor 37 to the cylindrical rotational member 41 while slowing down this rotation at the predetermined speed reduction ratio. The cylindrical rotational member 41 is rotatably supported by the input case 31C of the booster housing 31 via a roller bearing 42.

The rotation-linear motion conversion mechanism 43 is configured as, for example, a ball-screw mechanism. The rotation-linear motion conversion mechanism 43 includes the cylindrical (hollow) linear motion member 44 provided axially movably via a plurality of balls on an inner peripheral side of the cylindrical rotational member 41. For example, the liner motion member 44 can form the assist member together with the power piston 45. The power piston 45 is inserted inside the linear motion member 44 from an opening of the linear motion member 44 on the other axial side thereof. A flange portion 44A is provided at a position closer to an end portion of the linear motion member 44 on one axial side thereof. The flange portion 44A protrudes radially inward along an entire circumference. One end portion (a rear end portion) of the power piston 45 is in abutment with a surface (a front-side surface) of this flange portion 44A on the other side. Due to this abutment, the linear motion member 44 can be displaced to the other axial side (the front side) integrally with the power piston 45 on inner peripheral sides of the input case 31C and the cylindrical rotational member 41.

The power piston 45 is actuated (axially moved) by the electric actuator 36 to generate the hydraulic pressure in the master cylinder 21 (apply the brake hydraulic pressure to each of the wheel cylinders 4L, 4R, 5L, and 5R). The power piston 45 forms the assist member advanceable toward and retractable from the input member 32, and is axially thrust (moved) forward by the electric actuator 36. The power piston 45 includes an outer cylindrical member 45A, an inner cylindrical member 45B, and an annular member 45C.

The outer cylindrical member 45A of the power piston 45 is provided inside the linear motion member 44 axially displaceably (slidably movably) relative to this linear motion member 44. The inner cylindrical member 45B is provided inside the outer cylindrical member 45A. An end surface (one end surface) of the inner cylindrical member 45B on one axial side (a rear side) thereof is in abutment with the annular member 45C together with one end surface of the outer cylindrical member 45A. The input piston 34 of the input member 32 is fittedly inserted inside the inner cylindrical member 45B axially relatively movably (slidably movably).

A flange portion 45B1 is formed on the other axial side (the front side) of the inner cylindrical member 45B. The flange portion 45B1 protrudes radially inward along an entire circumference. This flange portion 45B1 (a surface thereof on the other side) faces (confronts) the reaction disk 47 together with the pressure reception portion 34B of the input piston 34. On the other hand, the flange portion 45B1 (a surface thereof on one side) serves as a step (a step X2 on the other side) brought into abutment with the input piston 34 of the input member 32, for example, when the input member 32 is displaced relative to the power piston 45 toward the front side (the left side in FIG. 2), which corresponds to the other axial side.

The annular member 45C is fixedly attached to an opening of the inner cylindrical member 45B on the one axial side thereof by being threadably engaged therewith. A flange portion 45C1 is formed on an axially intermediate portion of the annular member 45C. The flange portion 45C1 protrudes radially outward along an entire circumference. The flange portion 44A of the linear motion member 44 is in abutment with one side surface of this flange portion 45C1. On the other hand, the outer cylindrical member 45A and the inner cylindrical member 45B are in abutment with the surface of the flange portion 45C1 on the other side. Further, the annular member 45C includes a cylindrical portion 45C2 extending toward the other axial side inside the inner cylindrical member 45B. The cylindrical portion 45C2 (a surface thereof on the other side) serves as a step (a step X3 on one side) brought into abutment with the input piston 34 (the piston main body 34A) of the input member 32, for example, when the input member 32 is displaced relative to the power piston 45 toward the rear side (the right side in FIG. 2), which corresponds to the one axial side.

The second return spring 46 is provided between the outer cylindrical member 45A of the power piston 45 and the output case 31B of the booster housing 31. The second return spring 46 constantly biases the power piston 45 in a braking release direction. Due to this configuration, the power piston 45 is returned to an initial position illustrated in FIG. 2 due to a driving force from the rotation of the electric motor 37 to a braking release side and the biasing force of the second return spring 46 when the brake operation is released.

The reaction disk 47 is the reaction force distribution member provided between the input member 32 (the input piston 34) and the power piston 45 (the inner cylindrical member 45B), and the output rod 48. The reaction disk 47 is formed into a disk-like shape with use of an elastic resin material such as rubber, and is in abutment with the input member 32 and the power piston 45. The reaction disk 47 transmits, to the output rod 48, the pressing force (the thrust force) transmitted from the brake pedal 6 to the input member 32 (the input piston 34) and the thrust force transmitted from the electric actuator 36 to the power piston (the inner cylindrical member 45B) (a booster thrust force). In other words, the reaction disk 47 distributes and transmits a reaction force P (refer to FIG. 4) of the brake hydraulic pressure generated in the master cylinder 21 to the input member 32 and the power piston 45, as the reaction force distribution member.

For example, when the brake pedal 6 is pressed, the power piston 45 is moved toward the reaction disk 47 side by the electric actuator 36 according to this pressing. At this time, the reaction disk 47 is elastically deformed as illustrated in FIGS. 4(A) and 4(B), which will be described below. In other words, the reaction disk 47 is elastically deformed between the flange portion 48A of the output rod 48, and the inner cylindrical member 45B of the power piston 45 and the input member 32 (the pressure reception portion 34B of the input piston 34). In FIG. 4, the shape of the inner cylindrical member 45B of the power piston 45, the shape of the pressure reception portion 34B of the input piston 34, and the like are schematically illustrated compared to FIG. 2.

The output rod 48 functions to output the thrust force of the input member 32 and/or the thrust force of the power piston 45 to the master cylinder 21 (the primary piston 23 thereof). The output rod 48 includes a large-diameter flange portion 48A provided on one end side thereof. The flange portion 48A is fitted to the inner cylindrical member 45B of the power piston 45 from outside while sandwiching the reaction disk 47 therebetween. The output rod 48 axially presses the primary piston 23 of the master cylinder 21 based on the thrust force of the input member 32 and/or the thrust force of the power piston 45.

Now, the rotation-linear motion conversion mechanism 43 has back-drivability, and can cause the cylindrical rotational member 41 to be rotated from the linear motion (the axial movement) of the linear motion member 44. As illustrated in FIG. 2, when the power piston 45 is retracted (maximumly retracted) to a return position (an initial position), the linear motion member 44 is brought into abutment with the closed end side of the input case 31C (the stopper member 31D). This closed end (a side surface of the stopper member 31D) functions as a stopper that regulates the return position of the power piston 45 via the linear motion member 44.

The flange portion 44A of the linear motion member 44 is in abutment with the power piston 45 (the annular member 45C thereof) from the rear side (the right side in FIG. 2). This allows the power piston 45 to be advanced alone separately from the linear motion member 44. That is, for example, suppose that the electric booster 30 has some abnormality, such as a malfunction of the electric motor 37 due to a disconnection or the like. In this case, the linear motion member 44 is returned to the retracted position together with the power piston 45 due to the spring force of the second return spring 46. This can contribute to prevention of a brake drag.

On the other hand, when the braking force is applied, the hydraulic pressure can be generated in the master cylinder 21 by displacing the output rod 48 toward this master cylinder 21 side via the reaction disk 47 based on the forward movement of the input member 32. At this time, when the input member 32 is advanced by a predetermined amount, the front end of the piston main body 34A of the input piston 34 is brought into abutment with the inner cylindrical member 45B (the flange portion 45B1 thereof) of the power piston 45. As a result, the hydraulic pressure can be generated in the master cylinder 21 based on the forward movements of both the input member 32 and the power piston 45.

The speed reduction mechanism 40 is not limited to the belt speed reduction mechanism, and may be constructed with use of another type of speed reduction mechanism such as a gear reduction mechanism. Further, the rotation-linear motion conversion mechanism 43, which converts the rotational motion into the linear motion, can also be constructed with use of, for example, a rack and pinion mechanism. Further, the speed reduction mechanism 40 does not necessarily have to be provided. For example, the electric booster 30 may be configured in such a manner that the cylindrical rotational member 41 is rotated directly by the electric motor, with the rotor of the electric motor provided at the cylindrical rotational member 41 and the stator of the electric motor also disposed around the cylindrical rotational member 41. Further, in the embodiment, the rotation-linear motion conversion mechanism 43 and the power piston 45 are prepared as different members from each other, but may be prepared while a part of each of them is integrated. For example, the power piston 45 and the linear motion member 44 of the rotation-linear motion conversion mechanism 43 may be integrated with each other. In other words, the assist member can be formed by the “power piston 45” and the “linear motion member 44 prepared as a member different from or a member integrated with the power piston 45”.

Next, the electric booster ECU 51 will be described.

The ECU 51, which controls the electric booster 30, includes, for example, a microcomputer, a driving circuit, and an electric power source circuit. The microcomputer includes, for example, a memory including a flash memory, a ROM, a RAM, an EEPROM, and/or the like (none of them illustrated), in addition to an arithmetic device (a CPU). The ECU 51 is an electric booster control unit that electrically drives and controls the electric motor 37. As illustrated in FIG. 1, an input side of the ECU 51 is connected to the brake operation sensor 7, the angle sensor 39, and the vehicle data bus 12. The brake operation sensor 7 detects the operation amount (or the pressing force) of the brake pedal 6. The angle sensor 39 detects the rotational position of the electric motor 37 (the movement amount of the power piston 45 corresponding thereto). The vehicle data bus 12 provides and receives a signal to and from the ECU 10 or 16 of another vehicle apparatus. On the other hand, an output side of the ECU 51 is connected to the electric motor 37 and the vehicle data bus 12.

The ECU 51 drives the electric motor 37 so as to increase the pressure in the master cylinder 21 according to, for example, the detection signal output from the brake operation sensor 7 (the brake pedal operation amount, i.e., the input member position) and the autonomous brake instruction from the ECU 16 (the autonomous brake braking instruction value). More specifically, the ECU 51 moves (displaces) the power piston 45 by controlling the electric actuator 36 (the electric motor 37) based on the first braking instruction value (an input member position) based on the operation performed on the brake pedal 6. In this case, the ECU 51 detects the relative position between the input member 32 and the power piston 45, and drives and controls the electric actuator 36 (the electric motor 37). Further, the ECU 51 moves (displaces) the power piston 45 by controlling the electric actuator 36 (the electric motor 37) based on the second braking instruction value (the autonomous brake instruction) input from the vehicle data bus 12 serving as the communication network between apparatuses of the vehicle.

In other words, the ECU 51 variably controls the braking hydraulic pressure to generate in the master cylinder 21 by driving the electric motor 37 based on the input member position or the autonomous brake instruction to move the power piston 45. As illustrated in FIG. 3, which will be described below, a motor driving circuit 52 and a control signal calculation processing portion 53 are mounted inside the ECU 51. The ECU 51 supplies an electric current to the electric motor 37 via the motor driving circuit 52 based on a driving signal calculated by the control signal calculation processing portion 53.

Then, when the electric current is supplied from the ECU 51 to the electric motor 37, the rotational shaft 37A of the electric motor 37 is rotationally driven. The rotation of the rotational shaft 37A is slowed down by the speed reduction mechanism 40, and is converted into the linear displacement of the liner motion member 44 (the displacement in the horizontal direction in FIG. 2) by the rotation-linear motion conversion mechanism 43. The linear motion member 44 is cylindrical, and contains the power piston 45 therein displaceably in the horizontal direction in FIG. 2 integrally with the power piston 45. The second return spring 46 is placed at the distal end side of the power piston 45 between it and the booster housing 31, and the power piston 45 is biased retractably in the same direction as the linear motion member 44 integrally with the linear motion member 44 when the linear motion member 44 is linearly displaced rightward in FIG. 2.

The reaction disk 47, which is the elastic member, is attached at the distal end of the power piston 45 (the inner cylindrical member 45B thereof), and the displacement of the power piston 45 is transmitted to the primary piston 23 of the master cylinder 21 via the reaction disk 47. The reaction disk 47 combines the thrust forces of the input member 32 and the power piston 45, and transmits them to the primary piston 23 of the master cylinder 21. Along therewith, the reaction disk 47 distributes the reaction force from the primary piston 23 derived from the brake hydraulic pressure generated in the master cylinder 21 to the input member 32 and the power piston 45.

In FIG. 2, the primary piston 23 does not block the route for supplying the brake fluid that connects the reservoir 29 and the master cylinder 21 to each other, and the hydraulic pressure is not generated inside the master cylinder 21 (the hydraulic chambers 25 and 26). From this state, the hydraulic pressure can be generated in the master cylinder 21 by driving the electric motor 37, displacing the primary piston 23 leftward in FIG. 2, blocking the route for supplying the brake fluid that connects the reservoir 29 and the master cylinder 21 to each other, and further displacing the primary piston 23.

The power piston 45 has the cylindrical shape as a whole, and the input member 32 is inserted through inside the power piston 45. The input member 32 is installed slidably independently of the displacement of the power piston 45 relative to this power piston 45, and contactably at the distal end thereof with the reaction disk 47. In addition, the steps for limiting the displacement relative to the input member 32 (i.e., the other-side step X2 and the one-side step X3) are provided at portions inside the power piston 45 that slide on the input member 32. For example, when the driver presses the brake pedal 6 without the electric motor 37 driven, the input member 32 is advanced, and the piston main body 34A of the input piston 34 is brought into abutment with the other-side step X2 (the side surface on the flange portion 45B1) of the inner cylindrical member 45B of the power piston 45.

As a result, the power piston 45 is separated from the linear motion member 44 and is advanced together with the input member 32, thereby being able to generate the hydraulic pressure in the master cylinder 21. On the other hand, when the power piston 45 is thrust forward by driving the electric motor 37 without the brake pedal 6 pressed by the driver, the one-side step X3 (the end surface of the cylindrical portion 45C2) of the annular member 45C of the power piston 45 is brought into abutment with the piston main body 34A of the input piston 34. As a result, the input member 32 is thrust forward integrally with the power piston 45.

Further, the first return spring 35, which serves as an input spring, is provided between the input member 32 (the input rod 33) and the power piston 45 or the linear motion member 44 (between the input rod 33 and the power piston 45 in FIG. 2). A load of the first return spring 35 varies according to the relative position between the input rod 33 of the input member 32 and the power piston 45. The first return spring 35 is mounted so as to apply a load to the input member 32 in a direction for returning the brake pedal 6 to an initial position (a direction for axially separating the input rod 33 and the power piston 45 away from each other).

Next, FIG. 3 illustrates a configuration and signals regarding the operation for generating the hydraulic pressure by the electric booster 30, and processing performed by the control signal calculation processing portion 53 inside the electric booster ECU 51.

As illustrated in FIG. 3, the ECU 51 of the electric booster 30 includes the motor driving circuit 52 and the control signal calculation processing portion 53. The motor driving circuit 52 controls the electric current to supply to the electric motor 37 based on the driving signal output from the control signal calculation processing portion 53 (an electric current feedback control portion 62, which will be described below), by which the rotation of the electric motor 37 is controlled. The rotation of the electric motor 37 (the rotational shaft 37A) is slowed down by the speed reduction mechanism 40 and is also converted into the linear displacement by the rotation-linear motion conversion mechanism 43, thereby causing the power piston 45, which is the assist member, to be linearly displaced axially (the horizontal direction in FIG. 2).

At this time, the electric current supplied to the electric motor 37 (the electric current flowing to the coil) is detected by an electric current sensor 52A provided at the motor driving circuit 52 of the ECU 51. Further, the rotational angle of the rotational shaft 37A of the electric motor 37 (i.e., the motor rotational position) is detected by the angle sensor 39. In this case, the displacement amount (the movement amount) of the power piston 45 can be calculated by using the rotational angle detected by the angle sensor 39, the speed reduction ratio of the speed reduction mechanism 40, and the linear displacement amount per unit rotational angle of the rotation-linear motion conversion mechanism 43. The control signal calculation processing portion 53 of the ECU 51 can perform control in such a manner that the displacement amount of the power piston 45 matches a predetermined displacement amount, i.e., the power piston 45 is displaced to a predetermined position by calculating the driving signal with use of, for example, a known feedback control technique. The detected angle may be the rotational angle after the speed is slowed down instead of the rotational angle of the rotational shaft 37A (the rotor). Further, the displacement sensor that directly detects the linear displacement of the power piston 45 may be used instead of the angle sensor 39.

As illustrated in FIG. 3, the control signal calculation processing portion 53 of the ECU 51 includes a brake operation input portion 54, a relative displacement amount calculation processing portion 55, an addition portion 56, an autonomous brake instruction calculation processing portion 57, a selection portion 58, an angle input portion 59, a position feedback control portion 60, an electric current input portion 61, and the electric current feedback control portion 62. An input side of the brake operation input portion 54 is connected to the brake operation sensor 7, and an output side thereof is connected to the addition portion 56. The brake operation input portion 54 amplifies the detection signal output from the brake operation sensor 7, and also outputs this amplified detection signal to the addition portion 56 as an input member position (a brake pedal operation amount) Xir.

The relative displacement amount calculation processing portion 55 functions to calculate, for example, a relative displacement amount ΔXcom, which is a target value of a distance (a relative displacement amount ΔX illustrated in FIG. 4) from a contact surface (a PR contact surface) between the inner cylindrical member 45B of the power piston 45 and the reaction disk 47 to the distal end surface of the input member 32 (the pressure reception portion 34B of the input piston 34). In other words, the relative displacement amount calculation processing portion 55 sets the relative displacement amount ΔXcom that should be held (maintained) between the PR contact surface and the distal end surface. An output side of the relative displacement amount calculation processing portion 55 is connected to the addition portion 56, and the relative displacement amount ΔXcom set by the relative displacement amount calculation processing portion 55 is output to the addition portion 56. The relative displacement amount ΔXcom is a value set so as to be able to acquire a pedal feeling desired for the driver (a control target value), and may be set to a constant value (a fixed value) or may be set to a variable value varying according to a change in a driving situation, such as a change in the vehicle speed.

An input side of the addition portion 56 is connected to the brake operation input portion 54 and the relative displacement amount calculation processing portion 55, and an output side thereof is connected to the selection portion 58. The addition portion 56 adds the relative displacement amount ΔXcom output from the relative displacement mount calculation processing portion 55 to the input member position Xir output from the brake operation input portion 54. The addition portion 56 outputs the added value (Xir+ΔXcom) to the selection portion 58 as a “power piston position instruction at the time of the pedal operation”.

An input side of the autonomous brake instruction calculation processing portion 57 is connected to the vehicle data bus 12, and an output side thereof is connected to the selection portion 58. For example, the autonomous brake instruction output from the ECU 16 via the vehicle data bus 12 is input to the autonomous brake instruction calculation processing portion 57. The autonomous brake instruction is input to, for example, the autonomous brake instruction calculation processing portion 57 as the hydraulic value to generate in the master cylinder 21. The autonomous brake instruction calculation processing portion 57 calculates the power piston position corresponding to the input autonomous brake instruction (the hydraulic value) based on, for example, a brake characteristic (characteristic data) indicating a relationship between the hydraulic pressure generated in the master cylinder 21 (the hydraulic value) and the position of the power piston 45, i.e., a “hydraulic pressure P-power piston position X characteristic”. The brake characteristic of the autonomous brake instruction calculation processing portion 57 is stored in the memory of the ECU 51. The autonomous brake instruction calculation processing portion 57 outputs the calculated power piston position to the selection portion 58 as a “power piston position instruction at the time of the autonomous brake”.

An input side of the selection portion 58 is connected to the addition portion 56 and the autonomous brake instruction calculation processing portion 57, and an output side thereof is connected to the position feedback control portion 60. The selection portion 58 compares the “power piston position instruction at the time of the pedal operation” output from the addition portion 56 and the “power piston position instruction at the time of the autonomous brake” output from the autonomous brake instruction calculation processing portion 57, and also selects a larger one of them. The selection portion 58 outputs the selected position instruction to the position feedback control portion 60 as the “power piston position instruction”.

An input side of the angle input portion 59 is connected to the angle sensor 39, and an output side thereof is connected to the position feedback control portion 60. The angle input portion 59 amplifies the detection signal output from the angle sensor 39, and also outputs this detection signal (i.e., the detection signal as a result of detecting the movement position of the power piston 45) to the position feedback control portion 60 as an actual power piston position Xpp.

An input side of the position feedback control portion 60 is connected to the selection portion 58 and the angle input portion 59, and an output side thereof is connected to the electric current feedback control portion 62. Based on the “power piston position instruction” output from the selection portion 58 and the actual power piston position Xpp output from the angle input portion 59, the position feedback control portion 60 calculates, for example, a difference (a positional difference) between them, and also outputs an electric current instruction to the electric current feedback control portion 62 so as to reduce this difference.

An input side of the electric current input portion 61 is connected to the electric current sensor 52A, and an output side thereof is connected to the electric current feedback control portion 62. The electric current input portion 61 amplifies the detection signal output from the electric current sensor 52A (the electric current signal flowing to the electric motor 37), and also outputs this detection signal to the electric current feedback control portion 62 as an actual electric current value.

An input side of the electric current feedback portion 62 is connected to the position feedback control portion 60 and the electric current input portion 61, and an output side thereof is connected to the motor driving circuit 52. Based on the electric current instruction output from the position feedback control portion 60 and the actual electric current (the detection signal) output from the electric current input portion 61, the electric current feedback control portion 62 outputs the driving signal (i.e., the driving signal for driving the electric motor 37) to the motor driving circuit 52 so as to reduce a difference between them. The electric motor 37 is driven (rotated) based on the driving signal output from the motor driving circuit 52.

Next, the processing and the operation of the electric booster 30 for generating the hydraulic pressure in the master cylinder 21 based on the operation performed on the brake pedal 6 by the driver will be described.

When there is neither the operation performed on the brake pedal 6 by the driver nor the autonomous brake instruction (the autonomous brake instruction value=0), the electric booster ECU 51 calculates the power piston position instruction serving as the instruction directed to the position of the power piston 45 in the following manner. That is, in this case, the ECU 51 calculates such a power piston position instruction that the power piston 45 maintains the relative displacement between the power piston 45 and the input member 32 so as not to block the route for supplying the brake fluid that connects the reservoir 29 and the master cylinder 21 to each other and so as to prohibit the distal end of the input member 32 (the distal end of the pressure reception portion 34B of the piston member 34) from contacting (abutting against) the reaction disk 47. Then, the ECU 51 outputs the driving signal to the electric motor 37 so as to maintain this position.

More specifically, the detection signal of the brake operation sensor 7 is converted into the input member position Xir by the brake operation input portion 54. The addition portion 56 adds the relative displacement amount ΔXcom from the power position desired to be maintained to the converted input member position Xir. When the autonomous brake instruction is not input, a value calculated from the addition is selected by the selection portion 58, and is also input from the selection portion 58 to the position feedback control portion 60 while being set as the “power piston position instruction”. The position feedback control portion 60 calculates the “electric current instruction” in such a manner that the calculated “power piston position instruction” and the “power piston position Xpp” calculated by converting the detection signal of the angle sensor 39 match each other, and outputs the calculated instruction to the electric current feedback control portion 62. The electric current feedback control portion 62 calculates the motor driving signal in such a manner that the calculated “electric current instruction” and the “electric value” calculated by converting the detection signal of the electric current sensor 52A match each other. For example, a known feedback control technique can be used for the calculation of such a motor driving signal.

Now, the relative displacement amount ΔXcom added to the input member position Xir is calculated by the relative displacement amount calculation processing portion 55. The relative displacement amount ΔXcom is a value for setting the distance from the contact surface (the PR contact surface) between the power piston 45 (the inner cylindrical member 45B) and the reaction disk 47 to the distal end of the input member 32 (the pressure reception portion 34B of the input piston 34) as an arbitrary value. More specifically, the relative displacement amount ΔXcom is determined in consideration of relationships between the dimensions of the components forming the electric booster 30 and respective origins of the input member position Xir and the power piston position Xpp recognized by the ECU 51 (the positions where they are in abutment with the booster housing 31).

In the embodiment, for simplification, assume that the relative displacement amount ΔXcom is the distance itself from the contact surface (the PR contact surface) between the power piston 45 and the reaction disk 47 to the distal end of the input member 32 (the distal end of the input member). Due to this method, the position of the power piston 45 can be displaced so as to keep the distance between the distal end of the input member and the PR contact surface at the arbitrary relative displacement amount ΔX independently of the brake pedal operation amount (i.e., the input member position). Therefore, the power piston 45 can be displaced according to displacing the input member 32 by operating the brake pedal 6. In this manner, the power piston 45 is displaced by the brake pedal operation, by which the primary piston 23 is moved via the reaction disk 47. As a result, the route for supplying the brake fluid that connects the reservoir 29 and the master cylinder 21 to each other is blocked, and the hydraulic pressure is generated in the master cylinder 21.

Now, the reaction disk 47 made of the elastic member is little elastically deformed when the hydraulic pressure is not generated in the master cylinder 21 and the force transmitted from the primary piston 23 to the reaction disk 47 via the output rod 48 (i.e., the reaction force P) is small. In this case, the distance between the distal end of the input member 32 (the pressure reception portion 34B of the input piston 34) and the reaction disk 47 is approximately equal to the distance from the contact surface between the power piston 45 and the reaction disk 47 to the distal end of the input member 32 (the pressure reception portion 34B).

However, when the hydraulic pressure is generated inside the master cylinder 21 and a large force starts to be transmitted from the primary piston 23 to the reaction disk 47 via the output rod 48, the reaction disk 47 is compressed due to the reaction force P illustrated in, for example, FIG. 4(A) and is elastically deformed so as to partially bulge to the inside of the power piston 45. In other words, the reaction disk 47 partially bulges into the power piston 45 so as to reduce the distance toward the distal end of the input member (the pressure reception portion 34B).

Then, when the reaction force P increases according to the increase in the hydraulic pressure in the master cylinder 21 and the deformation amount of the reaction disk 47 increases, the distance between the bulging portion of the reaction disk 47 and the distal end of the input member 32 (the pressure reception portion 34B) reduces. Further, when the reaction force P increases as illustrated in FIG. 4(B), the reaction disk 47 and the distal end of the input member 32 (the distal end surface of the pressure reception portion 34B) are eventually brought into contact with each other. At this time, the reaction force P transmitted to the reaction disk 47 according to the generated hydraulic pressure stars to be distributed at a ratio between a “contact area between the power piston 45 and the reaction disk 47” and a “contact area between the input member 32 and the reaction disk 47”, and be transmitted to each of them.

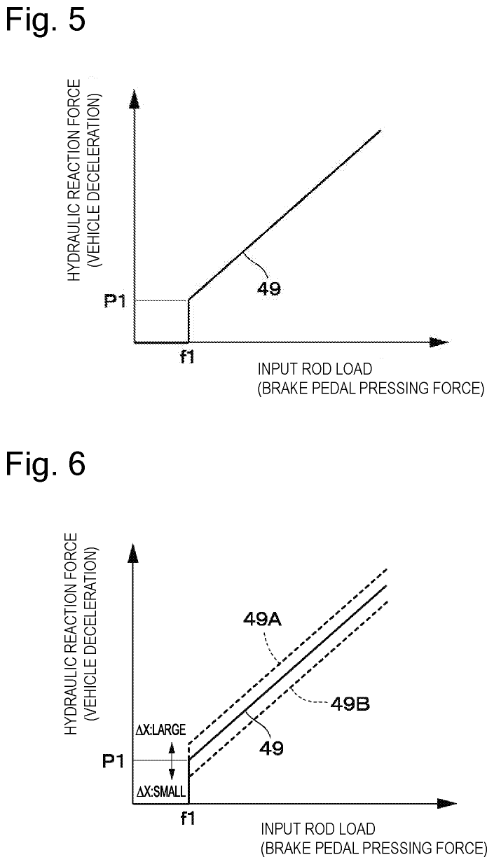

FIG. 5 illustrates a relationship between an input rod load applied to the input rod 33 of the input member 32 in the course of the generation of the hydraulic pressure in the master cylinder 21 (i.e., the pressing force on the brake pedal 6) and a hydraulic reaction force (a load) applied to the primary piston 23 (the output rod 48) that is generated due to the increase in the hydraulic pressure. Next, this relationship will be described with reference to FIG. 5. The driver, who operates the brake pedal 6 by pressing it, receives a hydraulic reaction force of zero until the hydraulic pressure is generated in the master cylinder 21, and the pressing force on the brake pedal 6 (the input rod load) during that is equal to the load f1 (refer to FIG. 5) of the first return spring 35 determined based on the amount of the displacement relative to the power piston 45. When the power piston 45 is displaced in the forward direction due to the actuation (the driving) of the electric actuator 36 according to the displacement of the input member 32, the hydraulic pressure starts to be generated in the master cylinder 21. However, until the distal end of the input member 32 is brought into contact with the reaction disk 47, the hydraulic reaction force is not transmitted from the master cylinder 21 to the input member 32, and therefore the input rod load is kept at the load f1 exerted by the first return spring 35.

After that, when the hydraulic pressure further increases in the master cylinder 21, the distal end of the input member 32 is brought into contact with the reaction disk 47. As a result, the hydraulic reaction force from the master cylinder 21 is distributed to the reaction force (the load) transmitted to the power piston 45 and the reaction force transmitted to the input member 32, and suddenly rises to a reaction force value P1 as indicated by a characteristic line 49 illustrated in FIG. 5. At this time, while the input rod load on a horizontal axis is kept at the load f1, the hydraulic reaction force on a vertical axis rises to the reaction force value P1.

In the characteristic line 49 illustrated in FIG. 5, the hydraulic reaction force on the vertical axis corresponds to a deceleration of the vehicle, and the input rod load is proportional to the pressing force on the brake pedal 6. Therefore, this characteristic is felt by the driver as a characteristic that raises the deceleration of the vehicle while keeping the pedal pressing force at the beginning of pressing the brake pedal 6 (the load f1) (a jump-in characteristic). This jump-in characteristic is a characteristic appearing when the vehicle starts to be braked (the deceleration is started), and therefore is desired to be kept constant on the same vehicle.

A jump-in hydraulic pressure that creates this jump-in characteristic is a hydraulic pressure when the reaction disk 47 and the input member 32 are brought into contact with each other (the reaction force value P1), and is changed according to not only a deformation characteristic (a characteristic according to the elastic deformation) of the reaction disk 47 but also the relative displacement amount ΔX between the input member 32 and the power piston 45. Therefore, it becomes possible to intentionally change the jump-in characteristic by intentionally changing the relative displacement amount ΔX depending on the vehicle.

However, the relative displacement amount ΔX is calculated based on the position of the power piston 45 (the power piston position) calculated by converting the value detected by the angle sensor 39 and the position of the input member 32 (the input member position) calculated by converting the value detected by the brake operation sensor 7. Therefore, the calculated relative displacement amount may contain an error from the actual relative displacement amount due to a mechanical tolerance or a sensor error. Then, such an error may prohibit the intended relative displacement amount ΔX from being realized, thereby causing an unintended change in the jump-in characteristic.

FIG. 6 illustrates a change in the relationship between the input rod load and the hydraulic reaction force (the change in the jump-in characteristic) due to the error in the relative displacement amount ΔX. For example, when the actual relative displacement amount is larger than the relative displacement amount recognized by the ECU 51 due to the mechanical tolerance, the sensor error, or the like, the jump-in hydraulic pressure increases. In other words, when the distance between the distal end of the input member 32 and the reaction disk 47 is large, a greater hydraulic reaction force is required to allow them to contact each other, and therefore the jump-in hydraulic pressure exceeds the reaction force value P1 as represented by a characteristic line 49A indicated by a broken line in FIG. 6. On the other hand, when the actual relative displacement amount is smaller than the relative displacement amount recognized by the ECU 51, the jump-in hydraulic pressure reduces. In other words, when the distance between the distal end of the input member 32 and the reaction disk 47 is small, a smaller hydraulic reaction force is required to allow them to contact each other, and therefore the jump-in hydraulic pressure falls below the reaction force value P1 as represented by a characteristic line 49B indicated by a broken line in FIG. 6.

Therefore, in the first embodiment, the relative position between the input member 32 and the power piston 45 is measured and the error due to the sensor error or the mechanical tolerance is estimated to prevent such an unintended change in the jump-in characteristic (the brake characteristic). Then, the relative position (the relative displacement amount) ΔXcom for determining the movement amount of the power piston 45 with respect to the operation amount of the input member 32 is corrected based on a result of this estimation (an estimated error).

More specifically, the ECU 51 controls the electric actuator 36 (the electric motor 37) while estimating the error due to the sensor error or the mechanical tolerance by the relative displacement amount calculation processing portion 55, and correcting the relative position between the input member 32 and the power piston 45 (the relative displacement amount ΔXcom) based on this estimated error. This correction may be made to the position of the input member 32 (the input member position) that is detected by the brake operation sensor 7 or may be made to the position of the power piston 45 (the power piston position) that is detected by the angle sensor 39.

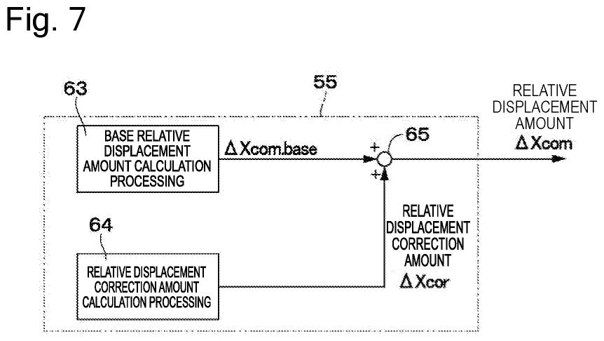

FIG. 7 illustrates the relative displacement amount calculation processing portion 55 according to the embodiment. The relative displacement amount calculation processing portion 55 includes a base relative displacement amount calculation processing portion 63, a relative displacement correction amount calculation processing portion 64, and an addition portion 65. The base relative displacement amount calculation processing portion 63 calculates a base value of the relative displacement amount as a base relative displacement amount ΔXcom.base. The base relative displacement amount ΔXcom.base is a value set from, for example, a calculation, an experiment, a test, or a simulation. The basic relative displacement amount calculation processing portion 63 may output a constant value as the base relative displacement amount ΔXcom.base, or may output a value variable according to the displacement amount or the displacement speed of the input member 32, the hydraulic value generated in the master cylinder 21, the deceleration of the vehicle, the vehicle speed, or the like. In this case, the hydraulic value, the deceleration of the vehicle, and the vehicle speed may be acquired by providing a sensor for detecting them to the ECU 51 (directly connecting the sensor and the ECU 51 to each other). Further, a signal transmitted from the ECU (for example, the ECU 10) of the other vehicle system connected via the vehicle data bus 12 may be used.

In this manner, the base relative displacement amount ΔXcom.base calculated by the basic relative displacement amount calculation processing portion 63 is output from the basic relative displacement amount calculation processing portion 63 to the addition portion 65. The addition portion 65 adds a relative displacement correction amount ΔXcor calculated by the relative displacement correction amount calculation processing portion 64 to the base relative displacement amount ΔXcom.base, and outputs a result of this addition as the relative displacement amount ΔXcom.

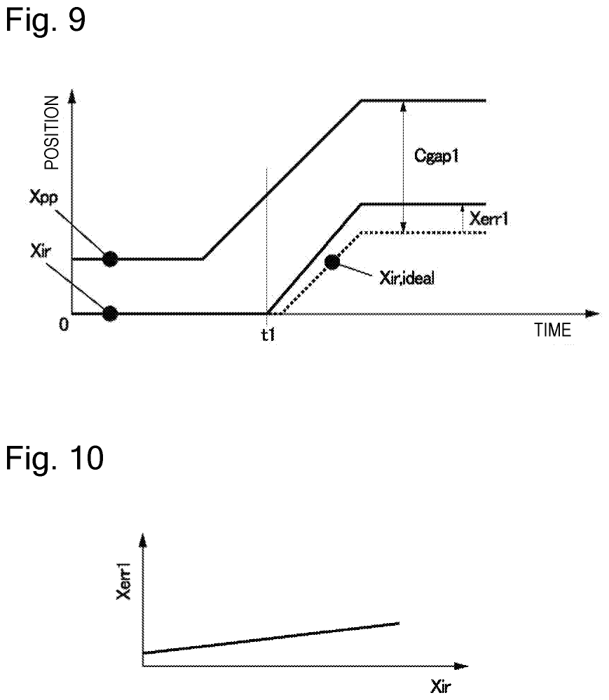

Next, the relative displacement correction amount ΔXcor calculated by the relative displacement correction amount calculation processing portion 64 will be described with reference to operation diagrams of FIG. 8 and a chronological characteristic line diagram of FIG. 9. FIG. 8 each illustrate a schematic (simple) half portion of a layout of the components of the electric booster 30 illustrated in FIG. 2.

FIG. 8 illustrate states in which the power piston 45 is thrust toward the master cylinder 21 side by driving the electric motor 37 without operating the brake pedal 6 as three stages in order from the top. The top diagram among FIG. 8, “(A) WAITING STATE” indicates a state in which the brake pedal 6 is not operated by the driver and the autonomous brake instruction is neither input from the vehicle data bus 12, i.e., a state waiting for the pressing of the brake pedal 6 and the autonomous brake instruction. This waiting state is a state in which the linear motion member 44 (the power piston 45) is held at a waiting position, which is a predetermined position, by driving the electric motor 37. The waiting state corresponds to such a state that, for example, the vehicle is powered on (an ignition switch is switched on), by which the actuation of the electric booster 30 including the ECU 51 is completed.

More specifically, when the vehicle is powered off, the linear motion member 44 is in an initial state (in an abutment state or at an origin) in abutment with the stopper member 31D of the booster housing 31 integrally with the power piston 45 based on the elastic force of the second return spring 46. The waiting state is a state in which the power piston 45 is thrust forward (advanced) by actuating the ECU 51 by a predetermined amount and the linear motion member 44 and the stopper member 31D are separated from each other by a predetermined amount from this initial state. This separation by the predetermine amount is set with the aim of avoiding undershooting of the actual position with respect to the control instruction and collision between the linear motion member 44 and the stopper member 31D when a return of the power piston 45 to the waiting state is abruptly attempted, such as when the driver suddenly releases the brake pedal 6.

Now, assume that a position at which the input member 32 is in abutment with the booster housing 31 (the stopper pieces 31D1 of the stopper member 31D) and cannot be retracted more than that is detected as an origin (0) with respect to the input member position Xir recognized by the control signal calculation processing portion 53. Further, assume that a position at which the power piston 45 (more specifically, the linear motion member 44 together with the power piston 45) is in abutment with the booster housing 31 (the side surface of the stopper member 31D) and cannot be retracted more than that is detected as an origin (0) with respect to the power piston position Xpp recognized by the control signal calculation processing portion 53. A position in the waiting state (a waiting position) is set to a value larger than zero in the embodiment, but the waiting state may be set to zero. Further, in this case, the relative displacement amount ΔX, which corresponds to the distance from the distal end of the power piston 45 (more specifically, the storage surface of the reaction disk 47) to the distal end of the input member 32, can be calculated from the following equation, an equation 1. In this equation, Crd represents a value specific to the apparatus that is acquired from the dimension of the component forming the electric booster 30, and a design value out of consideration of the tolerance can be used as the dimension of the component.

ΔX=Xpp−Xir+Crd [EQUATION 1]

When the electric motor 37 is driven and the power piston 45 is linearly moved (thrust forward) from this state, the power piston 45 and the input member 32 are brought into abutment with the step for limiting the relative displacement as illustrated in “(B) ABUT AGAINST STEP” at the middle among FIG. 8. In other words, the one-side step X3 of the power piston 45 (the end surface of the cylindrical portion 45C2 of the annular member 45C) is brought into abutment with one end edge of the piston main body 34A of the input member 32. After that, when the electric motor 37 is further driven and the power piston 45 is thrust forward, the input member 32 is linearly moved (thrust forward) integrally with the power piston 45 with the power piston 45 and the input member 32 kept in abutment with the step as illustrated in “(C) FURTHER THRUST FORWARD” at the bottom among FIG. 8. In this state, i.e., the state in which the input member 32 is linearly moved integrally with the power piston 45, the relationship between the power piston position Xpp and the input member position Xir ideally satisfies the following equation, an equation 2. In this equation, Cgap1 is a value specific to the apparatus that is acquired from the dimension of the component forming the electric booster 30.

Xpp−Xir=Cgap1 [Equation 2]

FIG. 9 illustrates temporal changes in the input member position Xir detected by the brake operation sensor 7 and the power piston position Xpp detected by the angle sensor 39 when the electric booster 30 operates from the state illustrated at the top to the state illustrated at the bottom among FIG. 8. As described above, at time 0 (the state illustrated at the top among FIG. 8), the power piston position Xpp is larger than zero, and the input member position Xir matches zero. After that, as the power piston position Xpp increases (the power piston 45 is thrust forward), at time t1, the power piston 45 and the input member 32 are brought into abutment with each other, and, after that, the input member position Xir increases according to the increase in the power piston position Xpp. Ideally, the input member position Xir increases in such a manner that the power piston 45 and the input member 32 are in abutment with each other when Xpp reaches “Xpp=Cgap1”, and keeps “Xir=Xpp−Cgap1” after that as indicated by the above-described equation 2.

However, the detection error due to the sensor error or the like is contained in the detected input member position Xir and power piston position Xpp, and Cgap1 is also different from the actual value due to the component tolerance or the like. These errors create an error in the relative displacement amount ΔX indicated in the equation 1, and this error may lead to the unintended error (the change) in the brake characteristic (the jump-in characteristic).

Therefore, in the embodiment, the relative displacement correction amount calculation processing portion 64 calculates the relative displacement correction amount ΔXcor with use of the power piston position Xpp and the input member position Xir detected at the time of the operation illustrated in FIG. 8. In this case, the relative displacement correction amount calculation processing portion 64 calculates an input member position Xir.ideal in the ideal state from the following equation, an equation 3 based on the above-described equation 1 with use of the power piston position Xpp detected when the power piston 45 is linearly moved (thrust forward).

Xir.ideal=Xpp−Cgap1 [Equation 3]

In this equation, the value calculated with use of the component design value out of consideration of the tolerance can be used as Cgap1. A difference between the input member position Xir.ideal in the ideal state that is calculated from the above-described equation 3 and the detected input member position Xir can be calculated from the following equation, an equation 4 as a detection error Xerr1.

Xerr1=Xir−Xir-ideal [Equation 4]

FIG. 10 illustrates a relationship between the input member position Xir and the detection error Xerr1 that are detected and calculated in FIG. 9, respectively. As illustrated in this diagram, FIG. 10, it is considered that, when the detection error Xerr1 has a positive value, the “detected input member position Xir has a larger value than the actual input member position” or the “detected power piston position Xpp has a smaller value than the actual power piston position”. In either case, it is considered that the relative displacement mount ΔX calculated with use of this detected value has a larger value than the actual relative displacement amount. Therefore, a result of inverting the sign of this calculated detection error Xerr1 is set as ΔXcor, and is calculated from the following equation, an equation 5.

ΔXcor=−Xerr1 [Equation 5]

As illustrated in FIG. 7, the relative displacement correction amount calculation processing portion 64 outputs ΔXcor calculated from this equation 5 to the addition portion 65 as the relative displacement correction amount ΔXcor. In other words, the relative displacement amount calculation processing portion 55 adds the relative displacement correction amount ΔXcor to the base relative displacement amount ΔXcom.base, and determines that this added value is the relative displacement amount ΔXcom. This method allows the actual relative displacement amount to approach the base relative displacement amount ΔXcom.base.

The calculated detection error Xerr1 is directly used as the correction amount ΔXcor in the first embodiment, but an average of results of measuring it a plurality of times may be used as the correction amount. Alternatively, only a part of them may be employed according to a tendency of a variation calculated based on a result of an actual dimension of the manufactured component. For example, a maximum value may be imposed on the detection error Xerr1 (a maximum value of the correction amount may be set). Further, the characteristic with respect to the input member position Xir may be expressed as a function approximation using a polynomial as illustrated in FIG. 10, or may be used as a processed constant value, such as a calculated maximum value, minimum value, and average value. Further, the electric booster 30 has been described referring to the example in which the power piston position Xpp increases in the first embodiment, but a similar method can be applied even in a case where the power piston position Xpp reduces.

Further, in the first embodiment, the operation for calculating the correction amount ΔXcor (the operation illustrated in FIG. 8) should be performed without the brake pedal 6 pressed by the driver. Further, the hydraulic pressure is generated in the master cylinder 21 as a result of the operation, and therefore the operation should be performed when receiving a braking instruction independent of the drivers' brake pedal operation (for example, the autonomous brake instruction) from the other ECU using the vehicle data bus 12, which is the communication net between vehicle ECUs, and thrusting only the power piston 45 forward based thereon to provide the braking force. Further, the operation should be performed when the driver does not operate the brake pedal 6 while the vehicle is stopped.

In any case, in the first embodiment, the electric actuator 36 (the electric motor 37) is subjected to a mechanical limitation on the displacement of the input member 32 relative to the power piston 45. More specifically, the relative displacement between the input member 32 and the power piston 45 is mechanically limited due to the abutment between the one-side step X3 of the power piston 45 (the side surface of the cylindrical portion 45C2 of the annular member 45C) and the one end edge of the piston main body 34A of the input member 32 when the electric actuator 36 is driven. On the other hand, the ECU 51 advances/retracts the power piston 45 independently of the movement of the input member 32, and determines the abutment state between the input member 32 and the power piston 45 under the mechanical limitation based on the detected relative position. Then, the ECU 51 corrects the relative position between the input member 32 and the power piston 45 based on this determination to control the electric actuator 36 (the electric motor 37). In this case, the ECU 51 determines that the input member 32 and the power piston 45 are brought into abutment with each other under the mechanical limitation and the input member 32 is moved based on the detected relative position when thrusting the power piston 45 forward independently of the movement of the input member 32, and corrects the relative position based on the detected value at this time to control the electric actuator 36 (the electric motor 37).

In this manner, according to the first embodiment, the ECU 51 advances/retracts the power piston 45 independently of the movement of the input member 32, and determines the abutment state between the input member 32 and the power piston 45 under the mechanical limitation based on the detected relative position. Due to this determination, the ECU 51 can use, for example, the state in which the input member 32 and the power piston 45 are in abutment with each other under the mechanical limitation as a reference (a reference for estimating the error). Then, the ECU 51 corrects the relative position between the input member 32 and the power piston 45 to control the electric actuator 36 (the electric motor 37) based on this reference and thus the estimated error. Therefore, the electric booster 30 can prevent the change in the brake characteristic regardless of the error due to the sensor error or the mechanical tolerance. In other words, the electric booster 30 can prevent the brake characteristic (for example, the jump-in characteristic) from deviating from the desired brake characteristic and acquire the desired brake characteristic regardless of the error due to the sensor error or the mechanical tolerance.

In addition, according to the first embodiment, the electric booster 30 can detect that the input member 32 and the power piston 45 are brought into abutment with each other and the input member 32 is moved under the mechanical limitation, and also use this detected value as the reference of the relative position (the reference for estimating the error). Therefore, the electric booster 30 can prevent the change in the brake characteristic by correcting the relative position based on this reference (detected value) to control the electric actuator 36 (the electric motor 37).

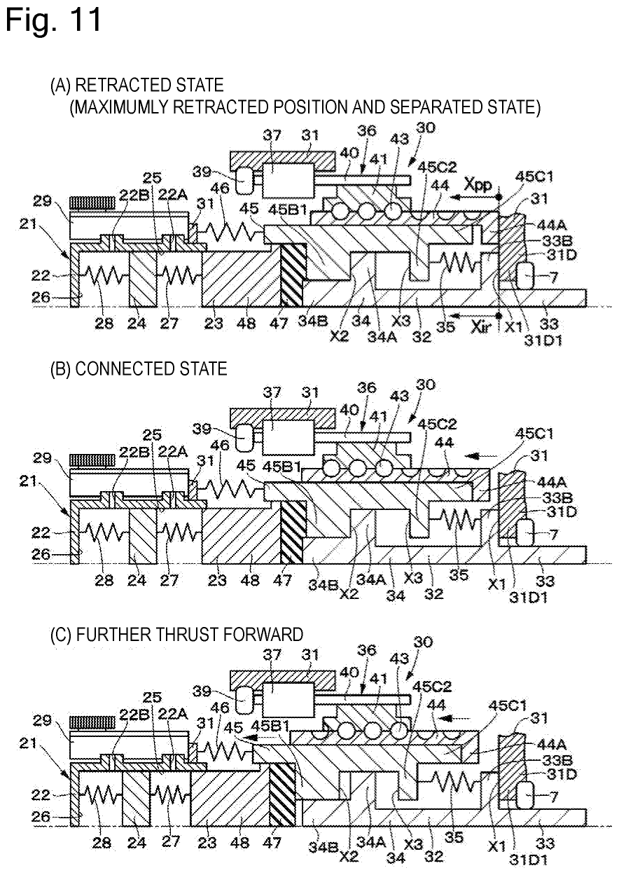

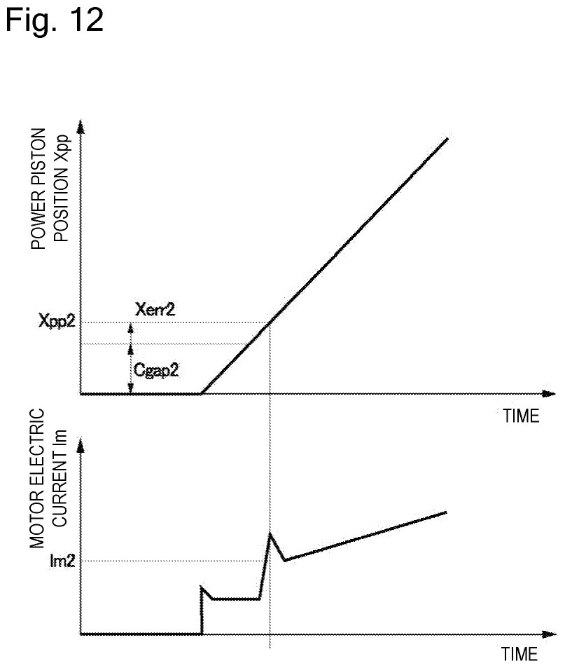

Next, FIGS. 11 and 12 illustrate a second embodiment. The second embodiment is characterized by being configured to determine the separation and the connection due to the abutment between the assist member and the input member according to a change in the electric current and also correct the relative position based on the relative position at this time. The second embodiment will be described, indicating similar components to the first embodiment by the same reference numerals and omitting descriptions thereof.

In the second embodiment, the relative displacement correction amount calculation processing portion 64 (refer to FIG. 7) also corrects the relative displacement correction amount ΔXcor, similarly to the first embodiment. The relative displacement correction amount ΔXcor according to the second embodiment will be described with reference to operation diagrams of FIG. 11 and chronological characteristic line diagrams of FIG. 12. In this case, the operation diagrams of FIG. 11 illustrate states in which the power piston 45 is thrust toward the master cylinder 21 side by driving the electric motor 37 without operating the brake pedal 6 as three stages in order from the top, similarly to FIG. 8 according to the above-described first embodiment. Further, in the second embodiment, the assist member is formed by the power piston 45 and the linear motion member 44.

The second embodiment is constructed assuming that the electric booster 30 operates as illustrated in FIG. 11. More specifically, as illustrated in the top view among FIG. 11, when the electric motor 37 is driven in an opposite direction (a retraction direction opposite from the advance direction) to linearly move the power piston 45 in the retraction direction, the power piston 45 is brought into abutment with the input member 32 before the linear motion member 44 is prohibited from being retracted by abutting against the stopper member 31D of the booster housing 31. In this case, the power piston 45 is brought into abutment with the input member 32 prohibited from being retracted in abutment with the stopper member 31D (the stopper pieces 31D1 thereof). This prohibits the power piston 45 from being retracted. Further, the electric booster 30 is assumed to be configured in such a manner that the linear motion member 44 is separated from the power piston 45 (the flange portion 44A of the linear motion member 44 is separated from the flange portion 45C1 of the annular member 45C of the power piston 45) and is slidably moved by continuously driving the electric motor 37 in the opposite direction from the state in which the power piston 45 is prohibited from being retracted. Further, at this time, the spring force of the second return spring 46 biased between the booster housing 31 and the power piston 45 is greater than the spring force of the first return spring 35 biased between the power piston 45 and the input member 32. Therefore, the second embodiment is constructed assuming that the power piston 45 is pressed against the booster housing 31 via the input member 32 in the retraction direction.

When the electric motor 37 is driven in the advance direction (the forward direction) to linearly move the linear motion member 44 from “(A) RETRACTED STATE (MAXIMUMLY RETRACTED POSITION OR SEPARATED STATE) illustrated at the top among FIG. 11, the linear motion member 44 and the power piston 45 are brought into abutment with each other as illustrated in “(B) CONNECTED STATE” at the middle among FIG. 11. In other words, the flange portion 44A of the linear motion member 44 is brought into abutment with the annular member 45C (the flange portion 45C1) of the power piston 45. After that, when the electric motor 37 is further driven in the advance direction, the power piston 45 is linearly moved (thrust forward) integrally with the linear motion member 44 as illustrate in “(C) FURTHER THRUST FORWARD” at the bottom among FIG. 11.

In the second embodiment, the relative displacement correction amount calculation processing portion 64 calculates the relative displacement correction amount ΔXcor with use of the power piston position Xpp and a motor electric current Im detected at the time of the operation illustrated in FIG. 11. In other words, FIG. 12 illustrate temporal changes in the power piston position Xpp detected by the angle sensor 39 and the motor electric current Im detected by the electric current sensor 52A when the electric booster 30 operates from the state illustrated at the top to the state illustrated at the bottom among FIG. 11. When the electric motor 37 is driven, first, an electric current for linearly moving only the linear motion member 44 is generated, and this electric current is detected by the electric current sensor 52A. After that, when the linear motion member 44 and the power piston 45 are brought into abutment with each other, the electric motor 37 requires an electric current sufficient to cause both the linear motion member 44 and the power piston 45 to be linearly moved, and compress the second return spring 46 at the same time, and therefore the detected electric current increases.

Ideally, the power piston position where the electric current increases as described above is located at a value Cgap2 determined based on the component dimensions of the linear motion member 44, the power piston 45, the input member 32, and the like, but, actually, is not located at Cgap2 due to, for example, a variation in the tolerance of the component dimension. To address this inconvenience, the detection error can be calculated from the following equation, an equation 6, assuming that Xpp2 represents a power piston position detected when the electric current increases as described above, and a detection error Xerr2 refers to a difference between this power piston position Xpp2 and Cgap2. In this equation, a value calculated with use of the component design value out of consideration of the tolerance can be used as Cgap2.

Xerr2=Xpp2−Cgap2 [Equation 6]

As illustrated in FIG. 12, it is considered that, when the calculated detection error Xerr2 has a positive value, the “detected power piston position Xpp2 has a smaller value than the actual power piston position” or the “distal end of the power piston 45 is actually located ahead of the design value due to the variation in the tolerance”. In either case, it is considered that the relative displacement mount ΔX calculated with use of this detected value has a larger value than the actual relative displacement amount. Therefore, a result of inverting the sign of this calculated detection error Xerr2 is set as ΔXcor, and is calculated from the following equation, an equation 7.

ΔXcor=−Xerr2 [Equation 7]

The relative displacement correction amount calculation processing portion 64 according to the second embodiment outputs ΔXcor calculated from this equation 7 to the addition portion 65 as the relative displacement correction amount ΔXcor. More specifically, the relative displacement amount calculation processing portion 55 adds the relative displacement correction amount ΔXcor to the base relative displacement amount ΔXcom.base, and sets this added value as the relative displacement amount ΔXcom. This method allows the actual relative displacement amount to approach the base relative displacement amount ΔXcom.base.

The calculated detection error Xerr2 is directly used as the correction amount ΔXcor in the second embodiment, but an average of results of measuring it a plurality of times may be used as the correction amount. Alternatively, only a part of them may be employed according to the tendency of the variation calculated based on the result of the actual dimension of the manufactured component. For example, a maximum value may be imposed on the detection error Xerr2 (a maximum value of the correction amount may be set). Further, the electric booster 30 has been described referring to the example in which the power piston position Xpp increases in the second embodiment, but a similar method can be applied even in the case where the power piston position Xpp reduces.

Further, in the embodiment, it is desirable that, basically, the operation for calculating the correction amount ΔXcor (the operation illustrated in FIG. 11) is performed without the brake pedal 6 pressed by the driver. However, this shall not apply to when there is a situation that the power piston 45 does not have to be linearly moved by the driving of the motor even with the brake pedal 6 pressed by the driver, such as immediately after the electric booster 30 is actuated.

The detection error Xerr2 when the driver presses the brake pedal 6 can be calculated from the following equation, an equation 8 with use of a power piston position Xpp2′ and an input rod position Xir2′ when the electric current exceeds a threshold value.

Xerr2=Xpp2′−Xir2′−Cgap2 [Equation 8]

Further, the increase in the motor electric current may be detected by a method of preparing an electric current threshold value Im2 and determining the increase in the motor electric current based on whether the motor electric current exceeds this threshold value as illustrated in the characteristic line diagram on the lower side of FIG. 12. Alternatively, this determination may be made based on an amount of the increase in the electric current per unit time or an amount of the increase in the electric current per unit power piston position.

In any case, in the second embodiment, the electric actuator 36 (the electric motor 37) is subjected to the mechanical limitation on the displacement of the input member 32 relative to the power piston 45 and the linear motion member 44. For example, the relative displacement between the input member 32 and the power piston 45 is mechanically limited due to the abutment between the other-side step X2 of the power piston 45 (one side surface of the flange portion 45B1) and the other end edge of the piston main body 34A of the input member 32. Further, the relative displacement between the linear motion member 44 and the power piston 45 is mechanically limited due to the abutment between the flange portion 45C1 of the power piston 45 and the flange portion 44A of the linear motion member 44. On the other hand, the ECU 51 advances/retracts the power piston 45 together with the linear motion member 44 independently of the movement of the input member 32, and determines the abutment state between the input member 32 and the power piston 45 and the linear motion member 44 under the mechanical limitation based on the detected relative position. Then, the ECU 51 corrects the relative position between the input member 32 and the power piston 45 based on this determination to control the electric actuator 36 (the electric motor 37).

In this case, in the second embodiment, the power piston 45 (i.e., the power piston 45 thrust forward by the electric actuator 36) of the electric actuator 36 (the electric motor 37) is biased in the retraction direction by the second return spring 46 as the spring. In this case, the power piston 45 and the linear motion member 44 are separated when they are retracted and the power piston 45 is brought into abutment with the input member 32, and the linear motion member 44 is permitted to be farther retracted than the power piston 45. In this case, the second return spring 46 is placed between the housing (the motor case 31A of the booster housing 31) of the electric actuator 36 (the electric motor 37) and the power piston 45.

On the other hand, the ECU 51 includes the electric current sensor 52A as a detection portion that detects the electric current increasing in proportion to the torque or the force generated by the electric actuator 36 (the electric motor 37). Then, the ECU 51 determines the separation and the connection between the power piston 45 and the linear motion member 44 due to the abutment with the input member 32 based on the detected electric current. The ECU 51 corrects the relative position based on the relative position detected at this time to control the electric actuator 36 (the electric motor 37).

The second embodiment is configured to determine the separation and the connection between the power piston 45 and the linear motion member 44 based on the motor electric current as described above, and a basic operation thereof is not especially different from the operation performed by the first embodiment. Especially, in the second embodiment, the electric booster 30 can determine the separation and the connection between the power piston 45 and the linear motion member 44 due to the abutment with the input member 32 based on the detected electric current, and also use the relative position detected at this time as a reference (a reference for estimating the error). Therefore, the electric booster 30 can prevent the change in the brake characteristic by correcting the relative position based on this reference (the relative position of the separation and the connection) and thus the estimated error to control the electric actuator 36 (the electric motor 37).

In the first embodiment, the electric booster 30 has been described referring to the example in which the electric motor 30 is configured to be able to drive the electric motor 37 of the electric booster 30 based on the autonomous brake instruction, i.e., include the autonomous brake function therein. However, the electric booster 30 is not limited thereto, and, for example, the autonomous brake function may be omitted. The same also applies to the second embodiment.

In the first embodiment, the electric booster 30 has been described referring to the example in which the rotational motor is employed as the electric motor 37 forming the electric actuator 36. However, the electric booster 30 is not limited thereto, and may employ, for example, a linearly movable motor (a linear motor) as the electric motor. In other words, various kinds of electric actuators can be employed as the electric actuator (the electric motor) that thrusts the assist member (the power piston or the linear motion member) forward. The same also applies to the second embodiment.

Further, each of the embodiments is only an example, and it is apparent that the configurations indicated in the different embodiments can be partially replaced or combined. For example, the electric booster 30 may determine the abutment state by the operation according to the first embodiment and make the correction based on the relative position thereof while being configured according to the second embodiment. In other words, the electric booster 30 may be configured to make both the corrections according to the first embodiment and the second embodiment.

Possible configurations as the electric booster based on the above-described embodiments include the following examples.

(1) According to a first configuration, an electric booster includes an input member configured to receive transmission of a part of a reaction force from a piston of a master cylinder coupled with a brake pedal, an assist member advanceable and retractable relative to this input member, an electric actuator configured to thrust the assist member forward by the movement of the input member, a reaction force distribution member configured to combine thrust forces of the input member and the assist member to transmit them to the piston of the master cylinder, and distribute the reaction force from the piston to the input member and the assist member, and a control device configured to detect a relative position between the input member and the assist member, and drive and control the electric actuator. The electric actuator is subjected to a mechanical limitation on a displacement of the input member relative to the assist member. The control device moves forward/backward the assist member independently of the movement of the input member and determines an abutment state between the input member and the assist member under the mechanical limitation based on the detected relative position, and corrects the relative position between the input member and the assist member to control the electric actuator.

According to this first configuration, the control device advances/retracts the assist member independently of the movement of the input member, and determines the abutment state between the input member and the assist member under the mechanical limitation based on the detected relative position. Due to this determination, the control device can use, for example, the state in which the input member and the assist member are in abutment with each other under the mechanical limitation as a reference. Then, the control device corrects the relative position between the input member and the assist member based on this reference to control the electric actuator. Therefore, the electric booster can prevent the change in the brake characteristic regardless of the error due to the sensor error or the mechanical tolerance. In other words, the electric booster can prevent the brake characteristic from deviating from the desired brake characteristic and acquire the desired brake characteristic regardless of the error due to the sensor error or the mechanical tolerance.

(2) According to a second figuration, in the first configuration, when thrusting the assist member forward independently of the movement of the input member, the control device determines that the input member and the assist member are brought into abutment with each other and the input member is moved under the mechanical limitation based on the detected relative position, and corrects the relative position based on the detected value at this time to control the electric actuator.

According to this second configuration, the electric booster can detect that the input member and the assist member are brought into abutment with each other and the input member is moved under the mechanical limitation, and also use this detected value as the reference of the relative position. Therefore, the electric booster can prevent the change in the brake characteristic by correcting the relative position based on this reference (detected value) to control the electric actuator.

(3) According to a third configuration, in the first configuration or the second configuration, the assist member of the electric actuator is biased in a retraction direction by a spring mounted between the assist member and a housing of the electric actuator, and is separated and permitted to be further retracted when being retracted and brought into abutment with the input member. The control device includes a detection portion configured to detect an electric current increasing in proportion to a torque or a force generated by the electric actuator, and determines the separation/connection of the assist member due to the abutment with the input member based on the detected electric current and corrects the relative position based on the detected value at this time to control the electric actuator.

According to this third configuration, the electric booster can determine the separation and the connection of the assist member due to the abutment with the input member based on the detected electric current, and also use the relative position detected at this time as a reference. Therefore, the electric booster can prevent the change in the brake characteristic by correcting the relative position based on this reference (the relative position of the separation and connection) to control the electric actuator.

The present invention is not limited to the above-described embodiments, and includes various modifications. For example, the above-described embodiments have been described in detail to facilitate better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each of the embodiments can also be implemented with another configuration added, deleted, or replaced with respect to a part of the configuration of this embodiment.

The present application claims priority under the Paris Convention to Japanese Patent Application No. 2017-183535 filed on Sep. 25, 2017. The entire disclosure of Japanese Patent Application No. 2017-183535 filed on Sep. 25, 2017 including the specification, the claims, the drawings, and the abstract is incorporated herein by reference in its entirety.

### REFERENCE SIGNS LIST

4L, 4R front wheel-side wheel cylinder (wheel cylinder)
5L, 5R rear wheel-side wheel cylinder (wheel cylinder)
6 brake pedal
7 brake operation sensor (operation amount detection device)
9 ESC
21 master cylinder
23 primary piston (piston)
30 electric booster
32 input member
33 input rod
34 input piston
36 electric actuator
37 electric motor
39 angle sensor (movement amount detection portion)
44 linear motion member (assist member)
45 power piston (assist member)
46 second return spring (spring)
47 reaction disk (reaction force distribution member)
48 output rod
51 electric booster ECU (control device)
52A electric current sensor (detection portion that detects an electric current)
55 relative displacement amount calculation processing portion
63 base relative displacement amount calculation processing portion
64 relative displacement correction amount calculation processing portion

1. An electric booster comprising:
an input member configured to receive transmission of a part of a reaction force from a piston of a master cylinder coupled with a brake pedal;
an assist member advanceable and retractable relative to this input member;
an electric actuator configured to thrust the assist member forward by the movement of the input member;
a reaction force distribution member configured to combine thrust forces of the input member and the assist member to transmit them to the piston of the master cylinder, and distribute the reaction force from the piston to the input member and the assist member; and
a control device configured to detect a relative position between the input member and the assist member, and drive and control the electric actuator,
wherein the input member is subjected to a mechanical limitation on a displacement thereof relative to the assist member, and
wherein the control device moves forward/backward the assist member independently of the movement of the input member and determines an abutment state between the input member and the assist member under the mechanical limitation based on the detected relative position, and corrects the relative position between the input member and the assist member to control the electric actuator.

2. The electric booster according to claim 1, wherein, when thrusting the assist member forward independently of the movement of the input member, the control device determines that the input member and the assist member are brought into abutment with each other and the input member is moved under the mechanical limitation based on the detected relative position, and corrects the relative position based on the detected value at this time to control the electric actuator.

3. The electric booster according to claim 1, wherein the assist member of the electric actuator is biased in a retraction direction by a spring mounted between the assist member and a housing of the electric actuator, and is separated and permitted to be further retracted when being retracted and brought into abutment with the input member, and
wherein the control device includes a detection portion configured to detect an electric current increasing in proportion to a torque or a force generated by the electric actuator, and determines the separation/connection of the assist member due to the abutment with the input member based on the detected electric current and corrects the relative position based on the detected value at this time to control the electric actuator.

4. The electric booster according to claim 2, wherein the assist member of the electric actuator is biased in a retraction direction by a spring mounted between the assist member and a housing of the electric actuator, and is separated and permitted to be further retracted when being retracted and brought into abutment with the input member, and
wherein the control device includes a detection portion configured to detect an electric current increasing in proportion to a torque or a force generated by the electric actuator, and determines the separation/connection of the assist member due to the abutment with the input member based on the detected electric current and corrects the relative position based on the detected value at this time to control the electric actuator.
